(19) United States
(12) Patent Application Publication
(10) Pub. No.: US 2023/0317919 A1
(43) Pub. Date: Oct. 5, 2023

(54) DEPOSITION OF FILMS ONTO BATTERY MATERIAL POWDERS

(71) Applicant: Coreshell Technologies, Inc., San Leandro, CA (US)

(72) Inventors: Sourav Roger Basu, Oakland, CA (US); Jonathan Tan, Oakland, CA (US); Michael D Slater, San Jose, CA (US); Donald A. Zehnder, San Carlos, CA (US); Matthew A. Kolaczkowski, Oakland, CA (US)

(21) Appl. No.: 18/043,471

(22) PCT Filed: Aug. 28, 2021
(86) PCT No.: PCT/US2021/048115

§ 371 Date: Feb. 28, 2023

Related U.S. Application Data
(60) Provisional application No. 63/072,149, filed on Aug. 29, 2020.

(51) Int. Cl. H01M 4/1391; H01M 4/04; B01J 2/00

(52) U.S. Cl. CPC H01M 4/1391; B01J 2/006; H01M 4/0407

(57) ABSTRACT

Disclosed herein are methods, systems, and compositions for the liquid-phase deposition of film coatings onto the surface of battery material powders. The battery material powders are introduced into a reaction vessel within which the coating is to be performed. A solvent is added to the reaction vessel to fluidize the battery material powders, thereby yielding a slurry composed of the solvent and powders. A first reagent is then added into the reaction vessel to react with the slurry to produce battery material powders comprising an adsorbed partial layer of the first reagent. A second reagent is added into reaction vessel to react with the battery material powders comprising an adsorbed monolayer of first reagent, thereby yielding coated battery material powders comprising at least one monolayer film.

### CROSS REFERENCE TO RELATED APPLICATION

This application claims the benefit of U.S. Provisional Application No. 63/072,149, filed on Aug. 29, 2020, which is incorporated by refence herein in its entirety for all purposes.

### BACKGROUND

The loss of capacity in batteries over time, such as lithium-ion batteries (LIBs), is typically the result of parasitic reactions originating from operating potentials outside of liquid electrolyte stability windows during cycling. To avoid such reactions, LIB manufacturers often limit key device attributes such as usable capacity, voltage and rate.

In some existing LIB compositions, the liquid electrolyte has been replaced with solid inorganic or solid ceramic electrolytes in order to improve battery performance and cycle lifetime. The substantially reduced (or eliminated) flammability of solid-state electrolytes also provides greatly improved safety of resulting batteries relative to the batteries that include liquid electrolytes. Solid-state electrolytes often display enhanced electrochemical stability as compared to liquid-phase electrolytes, thereby enabling batteries fabricated with solid-state electrolytes to be operated at wider voltage ranges.

However, solid-state electrolytes still present a number of interfacial issues when used in conjunction with standard rechargeable battery electrodes. For example, when paired with lithium-ion battery electrodes, interfaces between the solid-electrolyte and adjacent electrodes typically add ionic impedance, thereby reducing battery power density. These interfaces can also inhibit adequate wetting between electrode and electrolyte, and can also result in the formation of undesirable secondary phases due to thermodynamic instability.

Recent literature has focused on engineering an improved interfacial layer between battery electrodes and electrolytes in order to replace electrochemically grown layers and prevent formation of undesirable secondary phases. These articles describe the growth of various thin-film materials on electrode or electrolyte surfaces by atomic layer deposition (ALD), and demonstrate LIBs with reduced electrolyte decomposition and improved cycle stability. More specifically, the thin-film materials are grown on battery material powders prior to their formulation into fully-functional battery electrodes or electrolytes. For instance, oxides such as Al₂O₃, TiO₂ and ZrO₂ have improved battery cycle lifetime when grown on LiNiₓMn_{y}Co_{z}O₂, LiCoO₂, and LiMn₂O₄ cathode powders prior to their formulation into functional electrodes. In another example, for the class of solid-state electrolytes with formula Li_{w}LaₓM_{y}O₁₂ (where M is Nb, Ta, or Zr), oxides may be deposited on electrolyte powders prior to their assembly with a corresponding anode and cathode to form a functional battery. In this instance, the oxide layers prevent undesirable elemental interdiffusion between electrodes and solid electrolyte as well as the formation of undesirable secondary phases.

In U.S. PGPUB 2016/0351973, Albano et al disclose vapor-phase ALD and derivative deposition technologies to reduce deleterious side reactions by directly coating battery electrode constituent powders with various encapsulating coatings. In this technique, powders are first fluidized using an appropriate carrier gas within a reaction chamber to ensure coating uniformity. Vaporized precursors are then introduced in an alternating, sequential manner to grow films at a rate of one atomic monolayer per deposition cycle. While the technique is capable of growing uniform, conformal coatings on powders with Angstrom-level precision, scaling fluidized-bed-reactor (FBR) ALD to large-volume industrial production of coated powders presents many challenges. Firstly, the metalorganic precursors typically used to grow films of metal-containing compounds by FBR-ALD are pyrophoric; therefore, substantial safety infrastructure is necessary in order to handle such materials in large quantities. For high mass-loading in FBR-ALD, high partial pressures of precursors must be delivered to the reaction zone in order to saturate all available surfaces within a reasonable time. High vapor-pressures, in turn, are only possible for highly volatile precursors. Thus, in order for reagents to be compatible with FBR-ALD, they must comply with strict criteria. Such reagents have a low enough vapor pressure to be vaporized under vacuum at reasonable temperatures, while also being thermally stable at those temperatures. This vastly limits the number of reagents that can be applied to a vapor phase process.

For example, for the polymer-coating analogue to ALD, Molecular Layer Deposition (MLD), polymers can theoretically be grown in a monolayer-by-monolayer fashion, but their associated precursors cannot be vaporized to a sufficient quantity. Furthermore, in order to prevent precursor condensation during both ALD and MLD processes, both vapor-delivery and reaction zones need to be heated, thereby increasing system costs. Finally, at high mass loading, high carrier gas velocities are required in order to properly fluidize powders and prevent agglomeration as well as to ensure adequate heat transfer in case reactions must be conducted at elevated temperatures. This renders the FBR-ALD process impractical when attempting to apply coatings to powders in large batch sizes, as the quantity and velocity of carrier gas necessary to fluidize a batch of powders scales proportionally with the batch size. In addition, the recovery of the carrier gas in the FBR-ALD process is typically impractical as a result of its contamination with precursors during the FBR-ALD process; consequently, the larger the batch size, the higher the quantity of carrier gas wasted. Finally, FBR-ALD processes are typically performed at sub-atmospheric pressure within the reactor vessel; this is to maintain precursors in the gas phase and to promote transport of precursors from a high-pressure source to a low-pressure reaction zone. The need to evacuate reactor vessels in FBR-ALD presents a hindrance to its scalability and cost-effectiveness.

Proper fluidization of powders in the FBR-ALD process typically occurs within a narrow range of carrier gas velocities. At velocities below the “critical fluidization velocity”, the precursor and carrier gas pass through the void space between powders without sufficiently agitating the powders to yield a fluidized bed (often referred to as the “fixed bed” regime). Under such insufficient fluidization, powder surfaces are not all exposed to reaction during the coating process, thereby yielding coatings with poor conformality and incomplete coverage. At excessive carrier gas velocities, powders may be ejected from the bed when the carrier gas velocity exceeds the terminal velocity of the powder (also referred to as “entrainment”). To avoid active material loss due to powder expulsion, FBR-ALD coating processes are often performed using more than one vessel, with the primary vessel used to perform the coating process and with secondary vessels present to recover any expelled material. The need for multiple vessels in FBR-ALD also compromises the scalability and cost-effectiveness of the process

Another limitation of the FBR-ALD process is the tendency for powders within the bed to form agglomerates. In particular, fine powders, such as powders with D₅₀ of <25 µm, demonstrate strong agglomeration due to enhanced particle-to-particle Van Der Waals and electrostatic forces. In these instances, the agglomerates tend to behave as individual large particles within a fluidized bed. In worst-case scenarios, large masses of agglomerated powders are lifted within the bed as large plugs (“slugging” behavior). Under such conditions, fluidization is difficult and, in some cases, not possible. To counteract agglomeration within FBR-ALD, a mechanical vibrational force is often applied to the fluidized bed in addition to the fluidizing gas. The vibrations can serve to break up agglomerates into their constituent particles. However, applying vibrational energy to the fluidized bed represents an additional cost and technical complication that further limits the scalability of the FBR-ALD process.

Battery material powders, whether electrode active material powders or solid electrolyte powders, primarily possess particle size with D₅₀ <25 µm. As a result, battery material powders are classifiable as materials that are difficult to fluidize in gas-solid reactors such as those utilized in FBR-ALD due to their tendency to form agglomerates. This makes the uniform coating of battery material powders via FBR-ALD a particularly challenging process to scale. Furthermore, battery material powders often possess other physical characteristics, such as aspherical geometry and non-normal particle size distributions (e.g. bimodal size distribution), that further impede fluidization or result in non-uniform coating during FBR-ALD.

Vapor-phase deposition techniques such as FBR-ALD can be used for the deposition of electrically insulating coatings such as Al₂O₃. For example, Albano et al. exploit the insulating properties of Al₂O₃ to inhibit deleterious side reactions at the cathode-electrolyte interface in lithium-ion batteries operated at voltages exceeding 4 V. Such batteries typically employ nickel-containing cathode materials such as LiNio.₆Mn₀.₂Co₀.₂O₂ or cobalt-containing cathode materials such as LiCoO₂. An undesired side effect of the FBR-ALD process is that the insulating coatings impede electron transfer between cathode active material particles during battery operation, resulting in particle-to-particle electrical resistance and reduced battery power capability.

However, in instances where the battery employs a cathode material operated at voltages less than 4 V, such as the olivine cathode material LiFePO₄, little degradation occurs at the cathode-electrolyte interface because electrolytes commonly used in such batteries are electrochemically stable at such voltages. In such instances, adding an electrically insulating coating such as Al₂O₃ on LiFePO₄ powders only serves to increase particle-to-particle electrical resistance, thereby reducing power capability of the resulting battery.

Some alternatives to the monolayer-by-monolayer coating approach provided by FBR-ALD for applying thin film coatings to battery materials are described in existing literature. For example, in U.S. PGPUB 2018/0375089 A1, Gonser et al describe a living polymerization approach to particle functionalization for anode and electrolyte particles. Gonser et al. describe the addition of crown ether based monomers to improve lithium transport, fluorinated monomers for stability, and hydrogen bonding monomers to improve adhesion to electrode/electrolyte particles. In order to undergo the living polymerization the particles must first be pre-functionalized with various silanes in order to provide the functional handles. Despite the narrow polydispersity of living polymerization methodology, the control over coating thickness and composition is much less controlled than coatings applied in a monolayer-by-monolayer approach. The self-limiting nature of the monolayer-by-monolayer approach lends itself to more uniform coatings, as opposed to polymerization which is prone to self-terminating defects which prevent further growth. In addition, the monolayer-by-monolayer growth does not require the initiators, catalysts, and buffers necessary for a living polymerization which may be retained in the polymer matrix and be deleterious to battery performance. Finally, the polymers are specifically designed to soak up electrolyte within the polymer matrix. Gonser et al claim this electrolyte will decompose to form an active material/electrolyte interfacial layer with improved mechanical stability. However, with monolayer-by-monolayer growth, an inherently crosslinked layer can be produced which can exclude electrolyte, thereby greatly reducing the propensity for undesired parasitic electrolyte breakdown reactions. When used in coatings on electrode particles this may have the benefit of reduced first cycle loss, as lithium would be prevented from being trapped within the active material/electrolyte interfacial coating matrix.

Numerous bulk synthetic techniques have been defined in literature where powders of one material are embedded in a matrix of another material via low-cost, scalable techniques. Some such techniques involve solution-processing, such as sol-gel or polymerization techniques. However, within the context of applying thin films to battery electrode active material powders, such techniques are at a key disadvantage relative to the monolayer-by-monolayer growth yielded by vapor-phase MLD or ALD. By using bulk synthetic techniques to form a containing matrix in which active material powders are embedded, powders are necessarily dispersed far away from each other, with substantial matrix material present in-between. In such a scenario, the matrix material, which is typically electrically insulating, introduces a substantial impedance between active materials, thereby compromising the power capability of a resulting battery fabricated from such materials. If instead the matrix material is chosen so as to be electrically conductive, the matrix no longer functions as a barrier against deleterious side reactions, because the barrier is unable to minimize electron transfer between electrolyte and electrode.

For example, in U.S. PGPUB 2016/0020449 Hamers et al disclose a technique for applying coatings to silicon and carbon-based battery electrode active materials via electrical polymerization of a matrix surrounding active material powders (thereby yielding “functionalized” active materials). However, the method of Hamers et al, while providing a coating on the surface of active materials, lacks the precision necessary to deposit the coating in a monolayer-by-monolayer fashion. Such control over film growth is necessary to precisely tune the coating film thickness so as to provide a barrier against deleterious side reactions while simultaneously minimizing impedance between adjacent active material particles. This precision in film thickness can only be achieved by monolayer-by-monolayer growth techniques such as ALD and MLD.

Furthermore, precise control of the film growth, as afforded by monolayer-by-monolayer coating processes, is necessary in order to ensure that deposited films are uniform in thickness and also free of defects such as pinholes. Some alternative techniques to the monolayer-by-monolayer coating process previously described in literature include introducing battery material powders into solutions containing an excess of one or more coating reagents, followed by rinsing and drying of the powders, followed by a post-treatment process such as heat treatment. Such techniques inherently result in non-uniform, imprecisely thick coatings, because they do not provide reagents that react purely heterogeneously to generate a film on the powder surface. In contrast, the reagents also react homogeneously to produce undesired byproducts, such as nanoparticles. In the instance that nanoparticles form as a process byproduct, such nanoparticles may adhere to the powder surface, further exacerbating film roughness and film thickness nonuniformity. Furthermore, depending on the susceptibility of reagents to react homogeneously vs. heterogeneously, adding excessive reagent typically leads to uncontrolled quantities of reaction product as surface coating vs. undesired byproduct. This results in imprecise control of film thickness as well as imprecise control of film composition. Even in circumstances where coating reagents are introduced sequentially, instead of all at once, if reagents are provided in excess of what is required to produce a single monolayer, such a process will likely result in accumulated excess of one or more reagents, resulting in uncontrolled film growth and off-target film composition.

### SUMMARY

In one or more aspects, the present disclosure provides for a liquid-phase deposition method for coating thin films onto battery material powders, the method comprising: (a) introducing the battery material powders to be coated into a reaction vessel within which the coating is to be performed; (b) introducing a liquid solvent into the reaction vessel to fluidize the battery material powders, thereby yielding a slurry composed of the solvent and powders; (c) adding a first reagent solution comprising an at least first reactive substance into the reaction vessel to react with the slurry, thereby producing battery material powders comprising an adsorbed partial layer of the first reagent; and (d) adding a second reagent solution comprising an at least second reactive substance into the reaction vessel to react with the battery material powders comprising an adsorbed monolayer of first reagent, thereby yielding coated battery material powders comprising a thin film monolayer. The liquid-phase deposition of thin-film coatings on battery material powders provides numerous performance and scalability advantages over prior art techniques such as FBR-ALD, sol-gel and living polymerization.

In at least some implementations, steps (c) and (d) are repeated to yield a thin film coating composed of multiple stacked monolayers deposited on a plurality of the battery material powders within the slurry. In one or more implementations, the first reagent solution comprises more than one reactive substance. In one or more additional implementations, the second reagent solution comprises more than one reactive substance. In various examples, the reactive substances used to form different individual monolayers of the stacked monolayers can be different. As a result, at least some monolayers included in a stacked group of monolayers can have different compositions.

In one or more examples, a method comprising a liquid-phase deposition process for producing a monolayer film on battery material powders is described. The method includes providing a battery material powder to a reaction vessel. The battery material powder comprises a number of battery material particles. Additionally, a solvent is provided to the reaction vessel to produce a first slurry comprised of the solvent and the number of battery material particles. Further, a first reagent is provided to the reaction vessel. The first reagent comprises at least one first substance that reacts with the first slurry to produce intermediate battery material particles having an adsorbed partial layer. The adsorbed partial layer comprises the first substance adsorbed to surfaces of the number of battery material particles. Also, a second reagent is provided to the reaction vessel. The second reagent comprises at least one second substance that reacts with the adsorbed partial layer to produce a second slurry. The second slurry comprises the number of battery material particles coated with the monolayer film.

Further, one or more implementations of a system to perform a liquid-phase deposition process for producing a monolayer film on battery material powders is described. The system includes a reaction vessel and an agitation device disposed within the reaction vessel. The agitation device can be a mechanical rotating agitation device that is disposed within the contents of the reaction vessel. In addition, the system includes a first inlet pipe to provide a battery material powder to the reaction vessel. The battery material powder comprises a number of battery material particles. The system also includes a second inlet pipe to provide a solvent to the reaction vessel. The solvent combines in the reaction vessel with the battery material powder to produce a first slurry. Further, the system includes a third inlet pipe to provide a first reagent to the reaction vessel. The first reagent comprises at least a first substance that reacts with the first slurry to produce intermediate battery material particles having an adsorbed partial layer. The adsorbed partial layer comprises the first substance adsorbed to surfaces of the number of battery material particles. A fourth inlet pipe is included in the system to provide a second reagent to the reaction vessel. The second reagent comprises at least a second substance that reacts with the adsorbed partial layer to produce a second slurry. The second slurry comprises the number of battery material particles coated with the monolayer film.

One or more implementations of a battery are described. The battery comprises an anode comprising one or more anode active material layers. The battery also comprises a cathode comprising one or more cathode active material layers. Individual cathode active material layers of the one or more cathode active material layers comprise a number of cathode active material particles coated with a monolayer film. Additionally, the battery comprises one or more solid electrolyte layers disposed between the one or more anode active material layers and the one or more cathode active material layers. In one or more implementations, the battery is configured to operate at voltages of no greater than about 4 volts. In one or more implementations, the solid electrolyte is replaced with a plastic film separator coupled with liquid electrolyte.

### BRIEF DESCRIPTION OF THE DRAWINGS

FIG. 1 illustrates an example system to form films on battery material powders using solution phase deposition, according to one or more example implementations.

FIG. 2 illustrates an example process to form films on battery material powders using solution phase deposition, according to one or more example implementations.

### DETAILED DESCRIPTION

Provided herein are systems and methods for the liquid-phase deposition of materials in the form of thin film coatings on the surface of powders. One specific example of a powder material that can be coated using this technique is a battery material powder. Such techniques are more commercially and technically feasible for implementation into high-volume lithium-ion battery (LIB) manufacturing than FBR-ALD or other costly vapor-deposition processes. A “battery material powder” as used herein refers to finely granulated battery electrode or electrolyte constituent particles possessing an average diameter (across a given distribution of particle sizes, also referred to as “D₅₀”) between 1 nm and 100 microns.

The methods and systems of the present disclosure promote precise control of thickness and conformality of desired films by allowing reagents (e.g., precursors) to adsorb and move across powder surfaces, albeit through a liquid-phase delivery instead of vapor-phase. The liquid-phase delivery of reagents in the present disclosure takes advantage of the energy of solvation to mobilize reagents instead of relying on high-temperature thermal evaporation.

Additionally, the solvents used can possess high specific heat capacity and therefore can be employed as both heat transfer and precursor transfer media yielding faster, more efficient heating of powders. Precursors dissolved into solution are also more stable with regards to air ambient exposure as compared to their pure analogs, which are used in existing processes, yielding improved safety and easier handling. Furthermore, rather than using a complicated carrier gas flow system to fluidize particles, in solution, this dispersion can be accomplished with agitation by stirring. The use of stirring vastly simplifies the equipment needed for this process.

In state-of-the-art battery manufacturing, battery electrodes are typically fabricated via a process that includes casting of slurries composed of battery electrode constituent materials onto a foil current collector. Specifically, these slurries typically consist of battery electrode active materials (i.e., materials that act as charge-storage media), battery electrode inactive materials (such as materials that do not participate in charge-storage but provide other functions, such as adhesive binders), and an appropriately-chosen solvent to disperse said active and inactive materials. As such, a vessel typically exists ahead of the electrode fabrication process in which these slurry components are mixed (a “slurry mixer”). Therefore, in at least some implementations, the examples of coating techniques described herein can be incorporated into the slurry mixer, thereby providing a slurry mixer in which both thin-film coating processes and slurry mixing may take place within the same vessel. In one or more examples, a slurry, as used herein, can comprise a mixture of one or more liquids and one or more solids.

In one or more implementations, the method further comprises mixing or agitating the solvent with the battery material powders to fluidize a plurality of the battery material powders. The mixing or agitating can be carried out by an overhead stirrer. In one or more implementations, the mixing or agitating can also be performed using an ultrasonic probe. Solvent-assisted fluidization provides a significant advantage over the gas fluidization utilized in FBR-ALD processes for powder particle size distributions with D₅₀ < 25 µm, such as for typical battery material particle size distributions. This is because appropriately chosen solvents can form a chemisorbed surface monolayer on all particle surfaces (also known as a “solvent shell”), which can interrupt the Van der Waals and electrostatic particle-to-particle forces that typically cause agglomeration in powders with particle size distribution of D₅₀ < 25 µm during the FBR-ALD process.

The method can further comprise a step for heating the slurry. The heating of the slurry may be carried out by, for example, a heating jacket or by an immersion heater. The heating of the slurry during the solution-phase deposition of thin films on the battery material powders can improve film thickness uniformity, conformality, and attain desired film compositions. The solvent in the slurry, which acts to fluidize particles during the coating process, can also act as a heat transfer medium. As a result, a substantial advantage is yielded relative to heat transfer to particles via carrier gas in FBR-ALD. Higher specific heat capacities of solvents, coupled with their much higher density, yield much more efficient heat transfer as compared to that provided by the lower heat capacity, less-dense carrier gas used at sub-atmospheric pressure in the FBR-ALD process.

In one or more examples, at the end of the solution-phase coating process, the solvent can be recovered from the reaction vessel through a filtration mechanism used for separating the battery material powders from the solvent. Here as well, a substantial advantage is yielded relative to the limited recovery of the fluidizing carrier gas utilized in the FBR-ALD process. Whereas carrier gas is impractical to recover from the FBR-ALD process due to the difficult separation of precursor vapors from the carrier gas, the solvent in solution-phase coating can be maintained relatively free of excess precursor by limiting the quantity of precursor dosed in the solution-phase coating process to only that which is required to form the thin-film coating. Furthermore, the collection of residual solvent from the solution-phase coating process is much more feasible than the recovery of carrier gas in FBR-ALD, which must be continuously returned to a pressure vessel in the case that carrier gas recovery is desired.

In at least some implementations, the solution-phase coating process occurs within a single reactor vessel, without the need for secondary vessels to capture expelled powders, as no powder expulsion occurs during the solution-phase coating process, unlike in the FBR-ALD process, where secondary vessels are often required to capture entrained particles.

In various implementations, the solution-phase coating process is performed using precursors that possess a limited vapor pressure at room temperature, or which chemically decompose upon heating. Such precursors are incompatible with an FBR-ALD process, as they will not provide a sufficient vapor pressure in the reaction zone to saturate all available powder surfaces. However, such precursors are typically soluble in an appropriately chosen solvent, thereby allowing their use in a solution-phase coating process.

A significant disadvantage of the FBR-ALD process, particularly when applying thin-film coatings composed of compounds containing metals, is the need to utilize pyrophoric metalorganic precursors. The use of pyrophoric precursors necessitates substantial safety infrastructure to ensure their safe handling and to prevent accidental exposure to ambient air or moisture. In contrast, in a solution-phase coating process, many metalorganic precursors that are pyrophoric in their pure form can be rendered safe and non-pyrophoric simply by dissolving the precursors in an appropriate solvent and then diluting the solution to a concentration below the pyrophoric limit.

In at least some implementations, the ambient pressure within the solution-phase coating reaction vessel is maintained at atmospheric pressure. This provides a manifest advantage over the FBR-ALD process, where sub-atmospheric pressure within the reaction vessel is required to promote mass transport from the precursor source to the reaction zone. In contrast, in solution-phase coating processes, precursor solutions may be delivered to the reaction vessel through a variety of solution delivery techniques, such as through positive-displacement pumps, peristaltic pumps, metering pumps, centrifugal pumps, gear pumps, rotary vane pumps, diaphragm pumps, pressure transfer, or similar.

Additionally, in FBR-ALD, typically, the byproducts being monitored are limited to vapor byproducts, usually by residual gas analysis performed via mass spectrometry. In contrast, in a solution-phase coating process, non-volatile byproducts that possess some degree of solubility in the reaction solvent can be detected and monitored via in-situ spectroscopy such as infrared spectroscopy. For volatile byproducts that are insoluble or possess limited solubility in the reaction solvent in a solution-phase coating process, a residual gas analysis technique, such as mass spectrometry, can still be incorporated by sampling gas from the headspace immediately above the reaction solution.

Further, in one or more examples, electrode active material powders, such as cathode active material powders, transport both Lithium ions and electrons in and out of their crystalline matrix during battery operation. Solid state electrolyte powders, in contrast, only exchange Lithium ions during operation. As a result, an electrically insulating coating applied to a solid-state electrolyte does not negatively impact the power capability of an associated battery, insofar as it possesses a sufficiently high Lithium ionic conductivity. In addition, certain solid electrolytes are highly susceptible to conversion to undesirable secondary phases by ambient humidity; in such circumstances, a thin-film coating, such as those described herein, can provide a physical barrier to moisture, thereby rendering the electrolyte insensitive to ambient humidity.

Similar to solid electrolytes, numerous cathode active materials are also known to degrade in the presence of ambient humidity. In the instance where cathode active material powders are coated using a thin-film coating, such as those described herein, the thin-film coating provides a moisture diffusion barrier, allowing active material powders to be more easily handled in air without degradation. This imparts a substantial cost benefit by reducing the required investment in environmental controls in material handling areas in battery manufacturing facilities.

Cathode active materials in lithium-ion batteries, when fully or partially de-lithiated during charging, also simultaneously possess a reduced activation energy to loss of oxygen from their crystalline matrix. This presents a significant safety risk to lithium-ion battery operation. For example, in a scenario where a battery is heated to a point beyond the flash point of a typical organic electrolyte, the oxygen loss from the cathode can sustain conflagration, even under otherwise anaerobic conditions (also referred to as a “thermal runaway” scenario). In this regard, thin-film coatings that possesses low oxygen diffusivity, such as those described herein, when applied to cathode active materials, can block oxygen loss from the cathode, thereby yielding a battery that can be safely operated within a wider range of ambient temperatures.

As with liquid electrolytes, solid state electrolytes also often form high-impedance secondary phases at the electrode-electrolyte interface due to thermodynamic and electrochemical instability. By applying a thermodynamically and electrochemically stable interfacial coating on solid-state electrolyte particles, as described in one or more implementations herein, the formation of such secondary phases can be avoided.

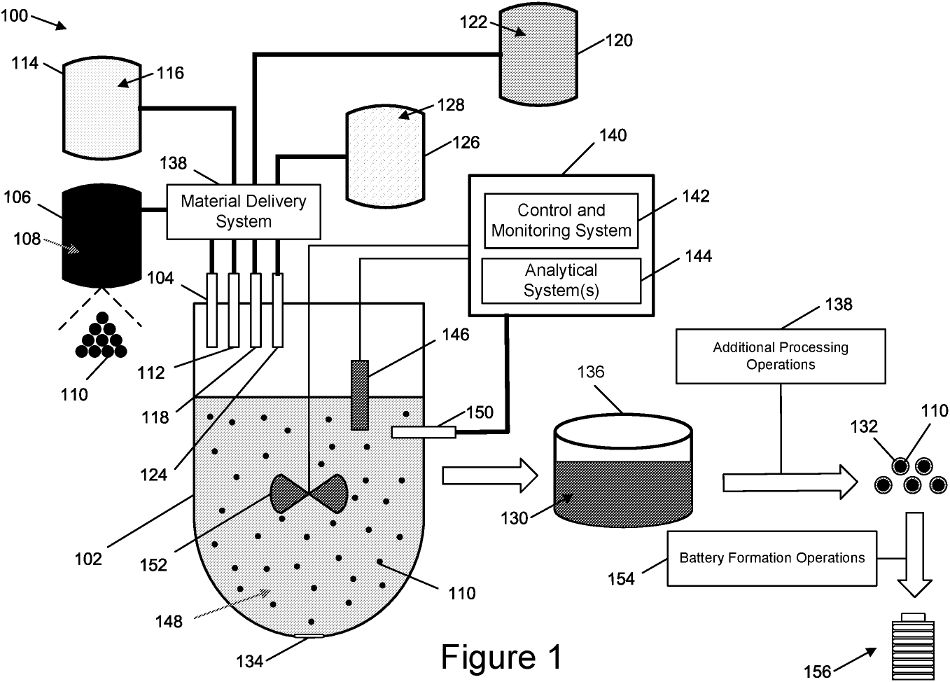

FIG. 1 illustrates implementation of an example system 100 to form films on battery material powders using solution phase deposition, according to one or more example implementations. The system 100 can include a reaction vessel 102. A number of materials can be added to the reaction vessel 102 to cause films to be formed over particles of battery materials. The reaction vessel 102 can have a capacity from about 50 milliliters (mL) to about 10,000 liters (L). In one or more examples, the reaction vessel 102 can have a capacity from about 1000 L to about 5000 L or from about 5000 L to about 10,000 L. In one or more additional examples, the reaction vessel 102 can have a capacity from about 50 mL to about 500 mL or from about 1 L to about 10 L. In one or more further examples, the reaction vessel 102 can have a capacity from about 50 L to about 500 L or from about 250 L to about 750 L.

The reaction vessel 102 can include a first inlet pipe 104. The first inlet pipe 104 can be coupled to a first material storage container 106. The first material storage container 106 can store a battery material powder 108. The battery material powder 108 can include a number of battery material particles 110. The battery material powder 108 can include one or more cathode material powders. In addition, the battery material powder 108 can include one or more anode material powders. Further, the battery material powder 108 can include one or more electrolyte material powders. In one or more illustrative examples, the battery material powder 108 can include one or more solid electrolyte powders.

A In one or more implementations, the battery material powder 108 can comprise one or more of the following: graphite, Si, Sn, Ge, Al, P, Zn, Ga, As, Cd, In, Sb, Pb, Bi, SiO, SnO₂, Si, Sn, lithium metal, Li₄Ti₅O₁₂, LiNb₃O₈, LiNiₓMn_{y}Co_{z}O₂, LiNiₓCo_{y}Al_{z},O₂, LiMn_{xN}i_{yOz}, LiMnO₂, LiFePO₄, LiMnPO₄, LiNiPO₄, LiCoPO₄, LiV₂O₅, sulfur or LiCoO₂ where x, y and z are stoichiometric coefficients. These represent nominal compositions and those skilled in the art will recognize that minor amounts, such as less than 0.05 equivalents, of other materials can be included as dopants to improve material characteristics while still being in the same material class as the nominal formula.

In one or more additional implementations, the battery material powder 108 can include a solid electrolyte powder comprising one or more of the following: LiPON, Li_{W}La_{X}M_{y}O₁₂ (where M is Nb, Ta, or Zr), Li_{xMPySz} (where M is Ge or Sn), Li_{w}AlₓM_{y}(PO₄)₃ (where M is Ge or Ti), LiₓTi_{y}M_{z}(PO₄)₃ (where M is Al, Cr, Ga, Fe, Sc, In, Lu, Y or La) or NaₓZr₂Si_{y}PO₁₂, GeS₂, LiₓP_{y}S_{z}, LiₓZn_{y}GeO₄ where in all cases, x, y and z represent stoichiometric coefficients.

The reaction vessel 102 can also include a second inlet pipe 112. The second inlet pipe 112 can be coupled to a second material storage container 114. The second material storage container 114 can store a solvent 116. The solvent 116 can form a first slurry in the reaction vessel 102 with the battery material powder 108. In one or more implementations, the solvent 116 can include one or more organic solvents. For example, the solvent 116 can include one or more alcohols. In one or more illustrative examples, the solvent 116 can include at least one of isopropyl alcohol or ethanol. In various examples, the solvent 116 can include one or more alcohol derivatives. To illustrate, the solvent 116 can include 2-methoxyethanol. In one or more additional examples, the solvent 116 can include less polar aprotic solvents. For example, the solvent 116 can include pyridine or tetrahydrofuran (THF). In one or more further examples, the solvent 116 can include one or more nonpolar organic solvents. To illustrate, the solvent 116 can include at least one of hexane or toluene. In still other examples, the solvent 116 can include one or more ethers. In various examples, the solvent 116 can include dioxane or diethyl ether.

Additionally, the reaction vessel 102 can include a third inlet pipe 118. The third inlet pipe 118 can be coupled to a third material container 120. The third material container 120 can store a first reagent 122. In one or more examples, the first reagent 122 can include one or more solvents and one or more reactive substances. The first reagent 122 can be combined with the first slurry comprised of the battery material powder 108 and the solvent 116 to form an intermediate slurry. In various examples, first reagent 122 can be combined with the first slurry comprised of the battery material powder 108 and the solvent 116 to form an adsorbed partial layer on the battery material particles 110. The absorbed partial layer can include at least one substance of the first reagent 120 absorbed to surfaces of the battery material particles 110. The adsorbed partial layer does not comprise a fully-formed monolayer film. Further, the reaction vessel 102 can include a fourth inlet pipe 124. The fourth inlet pipe 124 can be coupled to a fourth material container 126. The fourth material container 126 can store a second reagent 128. In one or more additional examples, the second reagent 128 can include one or more solvents and one or more reactive substances. In at least some implementations, at least one of the one or more solvents or the one or more reactive substances of the second reagent 128 can be different from at least one of the one or more solvents or the one or more reactive substances of the first reagent 122. The second reagent 128 can be combined with the absorbed partial layer on the battery material particles 110 to form slurry 130 that includes the battery material particles 110 coated with a monolayer film 132. In various examples, the slurry 130 can be removed from the reaction vessel 102 via an outlet 134 and stored in a fifth material container 136.

In one or more illustrative examples, the monolayer film 132 is formed on at least about 95% of the battery material powders 110 added to the reaction vessel 102, at least about 97% of the battery material powders 110 added to the reaction vessel 102, at least about 99% of the battery material powders 110 added to the reaction vessel, at least about 99.5% of the battery material powders 110 added to the reaction vessel, or at least about 99.9% of the battery material powders 110 added to the rection vessel 102. In one or more additional illustrative examples, the monolayer film 132 can be formed on 100% of the battery material powders 110 added to the reaction vessel 102.

The system 100 can also include a material delivery system 138. The material delivery system 138 can provide one or more materials to the reaction vessel 102. In one or more additional examples, the material delivery system 138 can cause one or more materials to be removed from the reaction vessel 102. The material delivery system 138 can implement one or more material delivery techniques to transport materials through the system 100. In various examples, the material delivery system 138 can implement one or more gravitational techniques to transport one or more materials through the system 100. In one or more additional examples, the material delivery system 138 can implement one or more mechanical techniques to transport one or more materials through the system 100. In one or more illustrative examples, the material delivery system 138 can include one or more positive-displacement pumps, one or more peristaltic pumps, one or more metering pumps, one or more centrifugal pumps, one or more gear pumps, one or more rotary vane pumps, one or more diaphragm pumps, one or more pressure transfer devices, one or more combinations thereof, and the like.

In one or more implementations, the second reagent 122 is selected to be able to react with the adsorbed first reagent to produce the complete monolayer film 132 that includes a compound coated onto the surface of the battery material powders 110. A non-limiting list of the compound formed includes:
(a) binary oxides of type AₓO_{y}, where A is an alkali metal, alkali-earth metal, transition metal, semimetal, metal or metalloid and x and y are stoichiometric coefficients;
(b) ternary oxides of type AₓB_{y}O_{z}, where A and B are any combination of alkali metal, alkali-earth metal, transition metal, semimetal, metal or metalloid and x, y and z are stoichiometric coefficients;
(c) quaternary oxides of type A_{w}BₓC_{y}O_{z}, where A, B and C are any combination of alkali metal, alkali-earth metal, transition metal, semimetal, metal or metalloid and w, x, y and z are stoichiometric coefficients;
(d) binary halides of type AₓB_{y}, where A is an alkali metal, alkali-earth metal, transition metal, semimetal, metal or metalloid, B is a halogen and x and y are stoichiometric coefficients;
(e) ternary halides of type AₓB_{y}C_{z}, where A and B are any combination of alkali metal, alkali-earth metal, transition metal, semimetal, metal or metalloid, C is a halogen and x, y and z are stoichiometric coefficients;
(f) quaternary halides of type A_{w}BₓC_{y}D_{z}, where A, B and C are any combination of alkali metal, alkali-earth metal, transition metal, semimetal, metal or metalloid, D is a halogen and w, x, y and z are stoichiometric coefficients;
(g) binary nitrides of type AₓN_{y}, where A is an alkali metal, alkali-earth metal, transition metal, semimetal, metal or metalloid and x and y are stoichiometric coefficients;
(h) ternary nitrides of type AₓB_{y}N_{z}, where A and B are any combination of alkali metal, alkali-earth metal, transition metal, semimetal, metal or metalloid and x, y and z are stoichiometric coefficients;
(i) quaternary nitrides of type A_{w}BₓC_{y}N_{z}, where A, B and C are any combination of alkali metal, alkali-earth metal, transition metal, semimetal, metal or metalloid and w, x, y and z are stoichiometric coefficients;
(j) binary chalcogenides of type AₓB_{y}, where A is an alkali metal, alkali-earth metal, transition metal, semimetal, metal or metalloid, B is a chalcogen and x and y are stoichiometric coefficients;
(k) ternary chalcogenides of type AₓB_{y}C_{z}, where A and B are any combination of alkali metal, alkali-earth metal, transition metal, semimetal, metal or metalloid, C is a chalcogen and x, y and z are stoichiometric coefficients;
(l) quaternary chalcogenides of type A_{w}BₓC_{y}D_{z}, where A, B and C are any combination of alkali metal, alkali-earth metal, transition metal, semimetal, metal or metalloid, D is a chalcogen and w, x, y and z are stoichiometric coefficients;
(m) binary carbides of type AₓC_{y}, where A is an alkali metal, alkali-earth metal, transition metal, semimetal, metal or metalloid and x and y are stoichiometric coefficients;
(n) binary oxyhalides of type AₓB_{y}O_{z}, where A is an alkali metal, alkali-earth metal, transition metal, semimetal, metal or metalloid, B is a halogen and x, y and z are stoichiometric coefficients;
(o) binary arsenides of type AₓAs_{y}, where A is an alkali metal, alkali-earth metal, transition metal, semimetal, metal or metalloid and x and y are stoichiometric coefficients;
(p) ternary arsenides of type AₓB_{y}As_{z}, where A and B are any combination of alkali metal, alkali-earth metal, transition metal, semimetal, metal or metalloid and x, y and z are stoichiometric coefficients;
(q) quaternary arsenides of type A_{w}BₓC_{y}As_{z}, where A, B and C are any combination of alkali metal, alkali-earth metal, transition metal, semimetal, metal or metalloid and w, x, y and z are stoichiometric coefficients;
(r) binary phosphates of type Aₓ(PO₄)_{y}, where A is an alkali metal, alkali-earth metal, transition metal, semimetal, metal or metalloid and x and y are stoichiometric coefficients;
(s) ternary phosphates of type AₓB_{y}(PO₄)_{z}, where A and B are any combination of alkali metal, alkali-earth metal, transition metal, semimetal, metal or metalloid and x, y and z are stoichiometric coefficients; and
(t) quaternary phosphates of type A_{w}BₓC_{y}(PO₄)_{z}, where A, B and C are any combination of alkali metal, alkali-earth metal, transition metal, semimetal, metal or metalloid and w, x, y and z are stoichiometric coefficients.

In the case that the reaction is between a non-ionic first reagent 122 comprising a metalorganic with a second reagent 128 comprising an oxidizer, as in the hydrolysis of trimethylaluminum, organic moieties are removed from the first reagent 122 and replaced with metal-oxygen-metal bonds, until metal-organic moiety bonds are fully saturated. In the case that the reaction is between a first reagent 122 comprising an ionic solution and a second reagent 128 comprising an ionic solution, as in the reaction between a first reagent 122 comprising a solution of Cd²⁺ and a second reagent comprising a solution of S²⁻ ions, the high solubility product constant of the reaction promotes precipitation of an ionic compound on surfaces of the battery material particles 110, in this case CdS, with the battery material particles 110 promoting heterogeneous film formation by minimizing surface energy.

In various implementations, the compound of the monolayer film 132 includes any combination of the following polymers: polyethylene oxide (PEO), poly vinyl alcohol (PVA), poly methyl methacrylate (PMMA), poly dimethyl siloxane (PDMS), poly vinyl pyrrolidone (PVP). In one or more additional examples, the compound of the monolayer film 132 comprises at least one or more polymers comprising a polyamide, polyimide, polyurea, polyazomethine, a fluoroelastomer, or any combination of these. Such polymers, when combined with battery material powders 110 comprising lithium salts such as LiClO₄, LiPF₆ or LiNO₃, among others, can yield a solid polymer electrolyte thin film.

In one or more additional implementations, the compound of the monolayer film 132 is composed of at least one or more metalcone polymers. In these implementations, the metalcone(s) is generated by a reaction between a first reagent 122 comprising a metalorganic and a second reagent 128 comprising an organic molecule. In these implementations, the first reagent 122 can include a metalorganic comprising one or more organic moieties and one or more metals. The one or more organic moieties can include at least one of one or more methyl groups, one or more ethyl groups, one or more propyl groups, one or more butyl groups, one or more methoxy groups, one or more ethoxy groups, one or more sec-butoxy groups, or one or more tert-butoxy groups, or one or more similar organic groups. In one or more examples, the one or more metals can comprise Al, Zn, Si, Ti, Zr, Hf, Mn, and/or V. The second reagent 128 can include an organic molecule comprising ethylene glycol, glycerol, erythritol, xylitol, sorbitol, mannitol, butanediol, pentanediol, hydroquinone, hexanediol, lactic acid, triethanolamine, p-phenylenediamine, glycidol, caprolactone, fumaric acid, aminophenol, ethylene diamine, 4,4′-oxydianiline, diethylenetriamine, ethylenediaminetetraacetic acid (EDTA), tris(hydroxymethyl)aminomethane, melamine, and/or diamino diphenyl ether. In one or more further implementations, the second reagent 128 can include water.

In one or more implementations, one or more components of at least one of the first reagent 122 or the second reagent 128 can be chosen from the following list: p-phenylenediamine, ethylene diamine, 2,2′-(ethylenedioxy)bis(ethylamine), 2,2-difluoropropane-1,3-diamine, melamine, benzene-1,3,5-triamine, terephthaloyl dichloride, succinyl chloride, diglycolyl chloride, tetrafluorosuccinyl chloride, hexafluoroglutaryl chloride, benzene-1,3,5-tricarbonyl trichloride, terephthalic acid, succinic acid, hexanedioic acid, diglycolic acid, 2,2,3,3-tetrafluorosuccinic acid, citric acid, propane-1,2,3-tricarboxylic acid, trimesic acid, 1,4 phenylene diisocyanate, hexamethylene diisocyanate, trans-1,4-cyclohexylene diisocyanate, 1,2-bis(2-isocyanatoethoxy)ethane 2,2-difluoro-1,3-diisocyanatopropane, 1,3,5-triisocyanatobenzene, 1,4 phenylene diisothiocyanate, 1,4-butanediisothiocyanate, 1,2-bis(2-isothiocyanatoethoxy)ethane, 2,2-difluoro-1,3-diisothiocyanatopropane, 1,3,5-triisothiocyanatobenzene, 1,4-dibromobenzene, 1,4-diiodobutane, 1,2-bis(2-iodoethoxy)ethane, octafluoro-1,4-diiodobutane, 3,3’,5,5′-tetrabromo-1,1′-biphenyl, 2,2’,7,7′-tetrabromo-9,9′-spirobifluorene, 1,2,5,6-tetrabromohexane, bisphenol A diglycidiyl ether, 4,4′-methylenebis(N,N-diglycidylaniline), butadienediepoxide, 1,4-bis(oxiran-2-ylmethoxy)butane, ethylene glycol diglycidyl ether, triethylene glycol, 2,2,3,3-tetrafluoro-1,4-butanediol diglycidyl ether, trimethylolpropane triglycidyl ether, PSS-octa[(3-glycidyloxypropyl)dimethylsiloxy] substituted, bisphenol A bis(chloroformate), 1,4-phenylene bis(chloroformate), ethylenebis(chloroformate), 1,4-Butanediol bis(chloroformate), tri(ethyleneglycol) bis(chloroformate), 2,2,3,3-tetrafluorobutane-1,4-diyl bis(carbonochloridate), propane-1,2,3-triyl tris(chloroformate), bisphenol A, ethylene glycol, diethylene glycol, 2,2,3,3-tetrafluoro-1,4-butanediol, 2,2,3,3,4,4-hexafluoro-1,5-pentanediol, titanium isopropoxide, glycerol, pentaerythritol, phloroglucinol, glucose, 2-ethyl-2-(hydroxymethyl)propane-1,3-diol, benzene-1,4-dithiol, 1,4-phenylenedimethanethiol, butane-1,4-dithiol, 2,2′-(Ethylenedioxy)diethanethiol, 2,2′-((2,2,3,3-tetrafluorobutane-1,4-diyl)bis(oxy))bis(ethane-1-thiol), trithiocyanuric acid, pentaerythritol tetrakis(3-mercaptopropionate), divinylbenzene, bicycle[2.2.1]hepta-2,5-diene, 1,5-cyclooctadiene, (vinylsulfonyl)ethane, di(ethylene glyocol) divinyl ether, 2,2,3,3,4,4-hexafluoro-1,5-bis(vinyloxy)pentane, trimethylolpropane triacrylate, pentaerythritol tetraacrylate, 1,4-diethynylbenzene, dipropargylamine, 4,7,10,16-pentaoxanonadeca-1,18-diyne, 3,3,4,4-tetrafluorohexa-1,5-diyne, 1,3,5-triethynylbenzene, 2,2′-bifuran, 2,2′-bithiophene, N,N′-bis-furan-2-ylmethyl-malonamide, bis(furan-2-ylmethoxy)dimethylsilane, 1,2-bis(furan-2-ylmethoxy)ethane, 2-(furan-2-ylmethoxymethyl)furan, 2,2′-(((2,2,3,3,4,4-hexafluoropentane-1,5-diyl)bis(oxy))bis(methylene))difuran, 2,2′-(((2-ethyl-2-((furan-2-ylmethoxy)methyl)propane-1,3-diyl)bis(oxy))bis(methylene))difuran, 1,1′-(methylenedi-4,1-phenylene)bismaleimide, N,N′-(1,4-phenylene)dimaleimide, bis-maleimidoethane, dithio-bis-maleimidoethane, 1,8-bismaleimido-diethyleneglycol, 1,1′-(2,2-difluoropropane-1,3-diyl)bis(1H-pyrrole-2,5-dione), 1,1’,1″-(benzene-1,3,5-triyl)tris(1H-pyrrole-2,5-dione), 1,4-diazidobenzene, 1,4-diazidobutane, polyethylene oxide bis(azide), 1,2-bis(2-azidoethoxy)ethane, 1,4-diazido-2,2,3,3-tetrafluorobutane, 1-azido-2,2-bis(azidomethyl)butane, 1,4-phenylenediboronic acid, 1,4-benzenediboronic acid bis(pinacol) ester, (E)-1-heptane-1,2-diboronic acid bis(pinacol) ester, 1,3,5-phenyltriboronic acid, tris(pinacol) ester, 1,4-bis(tributylstannyl)benzene, 2,5-bis(trimethylstannyl)thiophene, trans-1,2-bis(tributylstannyl)ethene, bis(trimethylstannyl)acetylene.

In one or more examples, at least some of the operations performed to produce the monolayer film 132 can be repeated in order to form a coating comprised of multiple stacked monolayers. For example, after a layer of the monolayer film 132 has been formed on the battery material particles 110, an amount of the first reagent 122 can be provided to the reaction vessel 102 and an additional adsorbed partial layer can be formed on the monolayer film 132. An amount of the second reagent 128 can then be provided to the reaction vessel 102 to produce a second monolayer film on the first monolayer film. Subsequent operations of providing the first reagent 122 to the reaction vessel 102 followed by providing the second reagent 128 to the reaction vessel 102 can be used to generate further monolayer films on the battery material particles 110. A thickness of the coating comprising one or more monolayer films can be based on the number of times that operations are repeated to produce the coatings having a desired thickness.

In one or more implementations, by including more than one reactive substance in the first reagent 122 or second reagent 128, the monolayer stoichiometry can be optimized to contain specific atomic ratios of more than two atomic species. Repetition of adding additional amounts of the first reagent 122 and the second reagent 128 including more than one reactive substance yields a final film composed of stacked monolayers where the total film stoichiometry can be optimized to contain specific ratios of more than two atomic species. In various implementations, reagent solutions which are chemically the same or which are chemically distinct from the first reagent 122 and second reagent 128 utilized in previous monolayer deposition cycles can be added to the reaction vessel 102 after one or more monolayer films are formed on the battery material particles 110. As a result, the composition of at least some individual monolayer films formed on the battery material particles 110 having multiple monolayer films can be different from one another. In such implementations, the composition of the film may be varied throughout the thickness of the film. An example of such an implementation is a film composed of stacked monolayers where the composition and ratio of the reagent solutions in each monolayer deposition is optimized such that the concentration of a specific atomic species within the final film generated from stacked monolayers is linearly graded throughout the thickness of the film. Another example of such an implementation is a thin film coating composed of a superlattice structure. In such an implementation, one pair of reagent solutions are repeated to yield one set of stacked monolayers of one composition, followed by a second pair of reagent solutions that are chemically distinct from the first pair of reagent solutions with the second pair being repeated to yield a second number of stacked monolayers of a different composition from the first set of stacked monolayers. In such an implementation, if the first and second sets of stacked monolayers are alternately repeated, the resulting film composition can be described as a superlattice structure.

In one or more illustrative examples, after forming the monolayer film 132 on the battery material particles 110, a first additional reagent that is different from the first reagent 122 can be added to the reaction vessel 102. In various examples, the first additional reagent can include one or more additional solvents and one or more additional reactive substances. The one or more additional reactive substances of the first additional reagent can be different from the one or more active substances of the first reagent 122. In at least some examples, the one or more additional solvents of the first additional reagent can be different from the one or more solvents included in the first reagent 122. The first additional reagent can form an additional adsorbed partial layer on the monolayer film 132. The additional absorbed partial layer can include at least one substance of the first additional reagent absorbed to the monolayer film 132. The additional adsorbed partial layer does not comprise an additional fully-formed monolayer film. Further, a second additional reagent can then be added to the reaction vessel 102. The second additional reagent can include one or more additional solvents and one or more additional reactive substances. In at least some implementations, the one or more additional reactive substances of the second additional reagent can be different from the one or more active substances of the second reagent 128. In at least some examples, the one or more additional solvents of the second additional reagent can be different from the one or more solvents included in the second reagent 128. The second additional reagent can be combined with the additional absorbed partial layer disposed on the monolayer film 132 to form an additional monolayer film. In one or more examples, one or more compounds of the additional monolayer film can be different from one or more compounds of the monolayer film 132.

In one or more illustrative examples, the coating can have a thickness from about 0.2 nm and 100 nm. In at least some implementations, individual layers of the monolayer film 132 can have a thickness from about 0.2 nm to about 1 nm. In one or more additional examples, the individual layers of the monolayer film 132 can have a thickness of no more than about 100 nanometers (nm). In one or more further example, the individual layers of the monolayer film 132 can have a thickness from about 1 and to about 10 nm. In still further examples, the individual layers of the monolayer film 132 can have a thickness from about 10 nm to about 100 nm.

In various implementations, at least a portion of the solvent 116 can be recycled and used in additional operations to form monolayer films on battery material particles. In one or more examples, a portion of the solvent after the second slurry is formed can be recovered with an efficiency of at least about 90%. Additionally, one or more new amounts of the solvent 116 can be provided to the reaction vessel 102 to perform one or more additional operations to further form additional monolayer films on the battery material particles 110 or to form additional monolayer films on a different batch of the battery material powder 108.

One or more additional components can be added to the reaction vessel 102 to produce the monolayer film 132 on the battery material particles. In various examples, the additional components can be added before or after at least one of the first reagent 122 or the second reagent 128 are added to the reaction vessel 102. The one or more additional components can include conductive and/or adhesive binders intended to render the slurry 130 ready for deposition on foil current collectors in order to generate a formed battery electrode. In these scenarios, the reaction vessel 102 can also be used to mix the battery material powders 110 and the one or more additional components. In one or more illustrative examples, the one or more additional components can include a conductive binder that includes conductive carbon. In one or more additional illustrative examples, the one or more additional components can include an adhesive binder that includes poly-vinylidene fluoride (PVDF).

In one or more additional implementations, the slurry 130 can undergo one or more additional processing operations 138 to produce battery material particles 110 having at least one monolayer film 132. For example, the slurry 130 can be subject to one or more heat treatments or drying operations to remove liquid from the slurry 130. The battery material particles 110 having at least one layer of the monolayer film 132 can also be exposed to a thermal treatment in the presence of an ambient atmosphere comprising a defined composition of gases. In various examples, the gases comprising the ambient can include at least one of O₂, ozone, N₂, or Ar. In one or more illustrative examples, the battery material particles 110 having at least one monolayer file 132 can be heated to temperatures up to 1000° C. within the presence of gases. In one or more additional examples, the battery material particles 110 having at least one layer of the monolayer film 132 can be heated while being exposed to a plasma comprising at least one of oxygen, fluorine, argon, hydrogen or nitrogen.

The system 100 can also include process systems 140. The process systems 140 can include a control and monitoring system 142 and one or more analytical systems 144. The control and monitoring system 142 can control the operation of devices included in the system 100. The one or more analytical systems 144 can include one or more analytical instruments that can analyze samples obtained from the reaction vessel 102.

In various examples, the control and monitoring system 142 can send signals to control the operation of one or more pieces of equipment included in the system 100. In various examples, the control and monitoring system 142 can provide signals to pieces of equipment included in the system 100 to cause the flow of material, such as at least one of the battery material powder 108, the solvent 116, the first reagent 122, or the second reagent 128, through the system 100. The control and monitoring system 142 can also provide signals to one or more pieces of equipment included in the system 100 to control the flow of materials out of the reaction vessel 102, such as via the outlet 134. Further, the control and monitoring system 142 can cause one or more reaction conditions to be present in the reaction vessel 102. To illustrate, the control and monitoring system 142 can cause the reaction vessel 102 to be heated in order to produce one or more ranges of temperatures in the reaction vessel 102. In one or more illustrative examples, a heating jacket can be disposed at least partly around the reaction vessel 102 to heat contents of the reaction vessel 102. In one or more additional examples, the control and monitoring system 140 can cause one or more ranges of pressures to be present in the reaction vessel 102. In one or more illustrative examples, the control and monitoring system 142 can maintain the pressure in the reaction vessel 102 to be about 1 atm.

In one or more further examples, the control and monitoring system 140 can receive input from a number of sensors of the system 100 and modify the operation of one or more pieces of equipment of the system 100 based on the sensor input. For example, the system 100 can include a probe 146 coupled to the control and monitoring system 142. The probe 146 can include an in-situ probe that is at least partially disposed within contents 148 of the reaction vessel 102. The probe 146 can detect formation of one or more non-volatile byproducts. The one or more byproduct can be at least partially soluble in at least one of the solvent 116, the first reagent 122, or the second reagent 128. In one or more illustrative examples, the probe 146 can include an infrared spectroscopy probe. In various examples, one or more additional probes can be disposed in the reaction vessel to detect the presence of one or more additional materials, such as volatile byproducts. To illustrate, in-situ process monitoring tools, such as the probe 146, can monitor the concentration of non-volatile reagents or byproducts within the contents 148 via a spectroscopic technique such as infrared spectroscopy. Further, the in-situ process monitoring tools can monitor the concentration of volatile byproducts within the headspace of the reaction vessel 102 above the contents 148 via a spectroscopic technique, such as mass spectrometry coupled with residual gas analysis. In various examples, a mass spectrometry probe can be operable in at least one of an ultraviolet electromagnetic radiation spectrum or a visible electromagnetic radiation spectrum

In various examples, reagents and non-volatile byproducts can include moieties that absorb light at particular and identifiable wavelengths. Changes in the optical absorption profile of the contents 148 can be used to monitor reaction progress. These changes can occur upon reaction of reagents with powders or from interaction with a chemical indicator intentionally added to the contents 148 or to an aliquot of reaction solution removed from the reaction vessel 102. Similarly, increases in an optical absorbance corresponding to byproducts can also be used to monitor the progression of the reaction. In one or more examples, changes in the optical absorption profile of the contents 148 can take place in response to one or more reactions between at least two of the first reagent 122, the second reagent 128, or the battery material powder 108.

In one or more examples, the quantity of each of the first reagent 122 and/or the second reagent 128 is controlled so as to provide a sufficient quantity to form one monolayer or less, but not in excess of one monolayer. In one or more implementations, the quantity of each of the first reagent 122 or the second reagent 128 added to the reaction vessel 102 used to form one monolayer or less can be estimated from the specific surface area of the battery material powder 108, where for a given mass of battery material powder 108, the total surface area of the battery material powder 108 multiplied by the expected thickness of one monolayer of a given adsorbed reagent multiplied by the volumetric molar density of the one monolayer of given adsorbed reagent provides an estimated number of moles required to generate one complete monolayer. In at least some examples, an in-situ process monitoring tool can determine the endpoint at which one complete monolayer is present on surfaces of the battery material powder 108 by measuring the concentration of unreacted reagent in the contents 148. In various examples, the in-situ process monitoring tool determines the endpoint where one complete monolayer has formed by measuring the concentration of reaction byproducts. The in-situ process monitoring tool can determine the endpoint signifying complete formation of one monolayer based on approaching asymptotic concentrations of byproducts and unreacted reagents. An in-situ monitoring technique coupled with reagent dosing valves can be programmed to automatically repeat adding amounts of the first reagent 122 and/or the second reagent 128 based on achievement of pre-defined threshold concentrations for unreacted reagents and byproducts. These automated process controls can also provide “closed-loop” process control. Reinforcement learning algorithms employed to analyze feedback from in-situ monitoring tools can be employed in the closed-loop computer control of coating systems so as to ensure monolayer-by-monolayer growth.

The system 100 can also include a sample feedthrough pipe 150. The sample feedthrough pipe 150 can be used to remove aliquots of the contents 148. The samples of the contents 148 can be provided to the one or more analytical systems 144. The one or more analytical systems 144 can include at least one of a liquid chromatography system or a mass spectrometry system that can analyze samples of the contents 148 obtained via the sample feedthrough pipe 150. In various examples, the one or more analytical systems 144 can analyze samples obtained via the sample feedthrough pipe 150 to determine quantity and/or formation of one or more products formed by reactions taking place in the reaction vessel 102.

Although not shown in the illustrative example of FIG. 1, the system 100 can also include a liquid level sensor to monitor a level of the contents 148 in the reaction vessel.

The reaction vessel 102 can include an agitation device 152. The agitation device 152 can included a mechanical device that rotates within the reaction vessel 102 to mix contents 148 of the reaction vessel 102. The agitation device 152 can include a blade that is disposed within the contents 148. In one or more examples, the agitation device 152 can be activated to mix the battery material particles 110 with the solvent 116. The agitation device 152 can also be activated to mix at least one of the first reagent 122 or the second reagent 128 with the contents 148 of the reaction vessel 102. In one or more illustrative examples, the agitation device 152 can include an overhead stirrer. In one or more additional illustrative examples, a sonic agitation device can be used to mix the contents 148 of the reaction vessel 102.

In one or more additional examples, one or more battery formation operations 154 can be performed using the battery material particles 110 coated with at least one layer of the monolayer film 132. The one or more battery formation operations 154 can produce one or more layers of a battery 156 using the battery material particles 110 coated with at least one layer of the monolayer film 132. For example, the one or more battery formation operations 154 can produce a cathode active material layer of the battery 156. In one or more additional examples, the one or more battery formation operations 154 can produce an anode active material layer of the battery 156. In one or more further examples, the one or more battery formation operations 154 can produce a solid electrolyte layer. In various examples, the battery 156 can include a liquid electrolyte with one or more separator layers in addition to one or more battery active material layers formed from the battery material particles 110 coated with at least the monolayer film 132. In one or more examples, the battery 156 can be configured to operate at voltages from about 1 volt (V) to about 20 V, from about 1 volt to about 10 volts, from about 5 volts to about 15 volts, from about 1 volt to about 3.5 volts, from about 4.5 volts to about 15 volts, or from about 5 volts to about 10 volts. In one or more examples, the battery 156 can be configured to operate at voltages no greater than about 4 V.

In various examples, at least a portion of the battery formation operations 154 can be performed in the reaction vessel 102. For example, the battery formation operations 154 can include one or more operations that form at least one of cathode active material layers or anode active material layers using the battery material particles 110 having the monolayer film 132. In these scenarios, one or more slurries can be produced in making the at least one of cathode active material layers or anode active material layers. In various examples, at least a portion of the slurries can be produced in the reaction vessel 102 after the battery material particles 110 having the monolayer film 132 are produced.

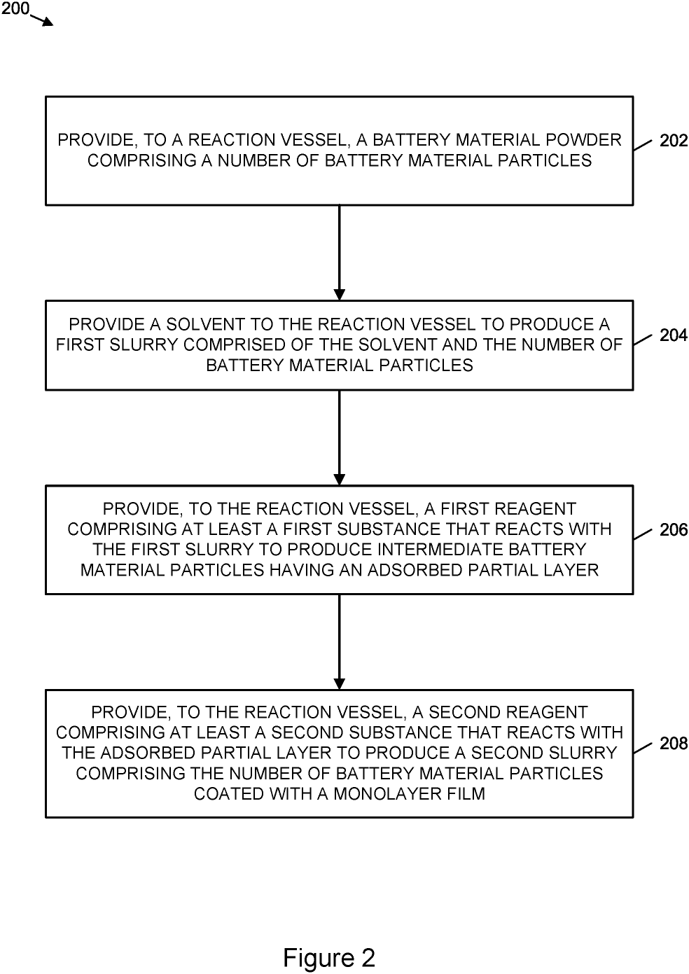

FIG. 2 illustrates an example process 200 to form films on battery material powders using solution phase deposition, according to one or more example implementations. The process 200 can include, at 202, providing, to a reaction vessel a battery material powder comprising a number of battery material particles. The battery material powder can comprise a cathode active material powder. Additionally, the battery material powder can comprise an anode active material powder. Further, the battery material powder can comprise a solid electrolyte powder

The number of battery material particles can have a d₅₀ of at least about 0.01 micrometers (µm), at least about 0.05 micrometers, at least about 0.1 micrometers, at least about 0.5 micrometers, at least about 1 micrometer, at least about 5 micrometers, or at least about 10 micrometers. The number of battery material particles can also have a d₅₀ of no greater than about 50 micrometers, no greater than about 45 micrometers, no greater than about 40 micrometers, no greater than about 35 micrometers, no greater than about 30 micrometers, no greater than about 25 micrometers, no greater than about 20 micrometers, or no greater than about 15 micrometers. In one or more illustrative examples, the number of battery material particles can have a d₅₀ of no greater than about 50 micrometers to at least about 0.01 micrometers. In one or more additional illustrative examples, the number of battery material particles can have a d₅₀ from about 1 micrometer to about 25 micrometers. In one or more further illustrative examples, the number of battery material particles can have a d₅₀ from about 0.5 micrometers to about 5 micrometers. In still other illustrative examples, the number of battery material particles can have a d₅₀ from about 5 micrometers to about 15 micrometers. Further, the number of battery material particles can have a d₅₀ from about 15 micrometers to about 25 micrometers. Additionally, the number of battery material particles can have a d₅₀ from about 10 micrometers to about 20 micrometers. In one or more additional examples, the battery material powder can have a non-normal particle size distribution, such as a bimodal size distribution. In various implementations, the battery material powder can have a relatively wide particle size distribution, with a full-width-half-max of at least 5 microns in the case of a normal (gaussian) particle size distribution.

In one or more further examples, the battery material particles can have an elongated geometry. To illustrate, the battery material particles can have an average aspect ratio of at least about 1.2:1, at about 1.3:1, at least about 1.5:1, at least about 1.7:1, at least about 2:1, or at least about 2.5:1. In one or more illustrative examples, the battery material particles can have an average aspect ratio from about 1.2:1 to about 3:1, from about 1.2:1 to about 2.5:1, from about 1.2:1 to about 2:1, from about 1.5:1 to about 2.5:1, or from about 2:1 to about 3:1.

The process 200 can also include, at 204, providing a solvent to the reaction vessel to produce a first slurry comprised of the solvent and the number of batter material particles. In one or more examples, the solvent and the battery material powder can be mixed using a rotating agitation device. For example, the rotating agitation device can be activated to mix the solvent and the battery material powder to produce the first slurry. Additionally, the rotating agitation device can be activated to mix the first slurry with the first reagent to produce the intermediate battery material particles. Further, the rotating agitation device can also be activated to mix the intermediate battery material particles with the second reagent to produce the second slurry.

In addition, at 206, the process 200 can include providing, to the reaction vessel, a first reagent comprising one or more solvents and at least a first reactive substance. The first substance can react with the first slurry to produce intermediate battery material particles. The intermediate battery material particles can have an adsorbed partial layer comprising the first substance adsorbed to surfaces of the number of battery material particles.

Further, at 208, the process 200 can include providing, to the reaction vessel, a second reagent comprising one or more solvents and at least a second reactive substance. The second substance can react with the adsorbed partial layer to produce a second slurry. The second slurry can comprise the number of battery material particles coated with at least one monolayer film. The monolayer film can include one or more polymeric materials. For example, the monolayer film can include a polyamide, polyimide, polyurea, polyazomethine, a fluoroelastomer, or any combination of these. Additionally, the monolayer film can include one or more metalcone polymers.

In one or more examples, bulk resistivity of the monolayer film is less than a bulk resistivity of the battery material powder. In addition, the battery material powder can be a solid electrolyte powder and the at least one monolayer film can provide a barrier to prevent water from interacting with the number of battery material particles. Further, the battery material powder can be an electrode active material powder and the monolayer film can provide a barrier to prevent water from interacting with the number of battery material particles. In various examples, at least one monolayer film formed on battery material particles can have a bulk water diffusivity of no greater than about 10⁻⁵ cm²/s. In one or more illustrative examples, at least one monolayer film formed on battery material particles can have a bulk water diffusivity from about 10⁻²² cm²/s to about 10⁻⁵ cm²/s, from about 10⁻²² cm²/s to about 10⁻¹⁵ cm²/s, from about 10⁻¹⁵ cm²/s to about 10⁻⁷ cm²/s, or from about 10⁻⁵ cm²/s to about 10⁻¹⁵ cm²/s to provide a barrier to prevent water from interacting with battery material particles.

In one or more additional examples, the battery material powder can be a cathode active material powder and at least monolayer film can provide a barrier to prevent oxygen from interacting with the number of battery material particles. In various examples, at least one monolayer film formed on the battery material particles can have a bulk oxygen diffusivity of no greater than about 10⁻⁵ cm²/s. In one or more illustrative examples, at least one monolayer film formed on the battery material particles can have a bulk oxygen diffusivity from about 10⁻ ²² cm²/s to about 10⁻⁵ cm²/s, from about 10⁻²² cm²/s to about 10⁻¹⁵ cm²/s, from about 10⁻¹⁵ cm²/s to about 10⁻⁷ cm²/s, or from about 10⁻⁵ cm²/s to about 10⁻¹⁵ cm²/s to provide a barrier to prevent oxygen from interacting with battery material particles.

In one or more examples, the reaction vessel can be heated. For example, the reaction vessel can be heating by a heating jacket disposed around the reaction vessel. In various examples, at least one of the first slurry, the intermediate battery material particles, or the second slurry can be heated in the reaction vessel. The temperature in the reaction vessel 102 can be at least about 30° C., at least about 50° C., at least about 75° C., at least about 100° C., at least about 125° C., at least about 150° C., or at least about 175° C. Additionally, the temperature in the reaction vessel can be no greater than about 300° C., no greater than about 275° C., no greater than about 250° C., no greater than about 225° C., or no greater than about 200° C. In one or more illustrative examples, the temperature in the reaction vessel can be from about 30° C. to about 300° C. In one or more additional illustrative examples, the temperature in the reaction vessel can be from about 30° C. to about 100° C. In one or more further illustrative examples, the temperature in the reaction vessel can be from about 200° C. to about 300° C. In still further illustrative examples, the temperature in the reaction vessel can be from about 100° C. to about 200° C. The temperature in the reaction vessel can also be from about 150° C. to about 250° C.

Additionally, a pressure within the reaction vessel can be from about 100 kilopascals (kPa) to about 110 kPa. In one or more illustrative examples, the pressure within the reaction vessel can be maintained at about 101 kPa.

In various examples, at least one of the first reagent or the second reagent has a vapor pressure at 1 atmosphere and at 25° C. from about 1 Pascal (Pa) to about 3000 Pa. In one or more examples, at least one of the first reagent or the second reagent can have a vapor pressure at 1 atmosphere and at 25° C. from about 1 Pa to about 500 Pa. In one or more additional examples, at least one of the first reagent or the second reagent can have a vapor pressure at 1 atmosphere and at 25° C. from about 500 Pa to about 1500 Pa. In one or more further examples, at least one of the first reagent or the second reagent can have a vapor pressure at 1 atmosphere and at 25° C. from about 1000 Pa to about 2000 Pa. In still further examples, at least one of the first reagent or the second reagent can have a vapor pressure at 1 atmosphere and at 25° C. from about 1500 Pa to about 2500 Pa. At least one of the first reagent or the second reagent can have a vapor pressure at 1 atmosphere and at 25° C. from about 2000 Pa to about 3000 Pa. Additionally, at least one of the first reagent or the second reagent can have a vapor pressure at 1 atmosphere and at 25° C. from about from about 1 Pa to about 1000 Pa. Further, at least one of the first reagent or the second reagent can have a vapor pressure at 1 atmosphere and at 25° C. from about 1000 Pa to about 2000 Pa. In various examples, at least one of the first reagent or the second reagent can have a vapor pressure at 1 atmosphere and at 25° C. from about 2000 Pa to about 3000 Pa.

Additionally, at least one of the first reagent or the second reagent has a decomposition temperature of at least about 25° C., at least about 30° C., at least about 35° C., at least about 40° C., at least about 45° C., or at least about 50° C. Further, at least one of the first reagent or the second reagent can include a solution comprising a material including a metal and an organic moiety. The solution can be diluted such that the solution does not ignite when in contact with ambient air and an undiluted form of the solution does ignite when in contact with ambient air.

After formation of the second slurry, one or more additional operations can be performed. To illustrate, one or more heat treatments can be applied to the second slurry to generate an additional powder that comprises the number of battery material particles coated with at least one monolayer film. Further, at least one electrode layer or at least one electrolyte layer of a battery can be formed from the additional powder. In one or more illustrative examples, a cathode active material layer can be formed from the additional powder derived from the second slurry that includes the battery material particles coated with at least one monolayer film.

### Example Implementations

Implementation 1. A liquid-phase deposition method for coating thin films onto battery material powders, the method comprising: (a) introducing the battery material powders to be coated into a reaction vessel within which the coating is to be performed; (b) introducing a solvent into the reaction vessel to fluidize the battery material powders, thereby yielding a slurry composed of the solvent and powders; (c) adding a first reagent into the reaction vessel to react with the slurry, thereby producing battery material powders comprising an adsorbed partial layer of the first reagent; and (d) adding a second reagent into reaction vessel to react with the battery material powders comprising an adsorbed monolayer of first reagent, thereby yielding coated battery material powders comprising a thin film monolayer.

Implementation 2. The method of implementation 1, wherein the monolayer possesses a thickness of no more than 100 nanometers (nm).

Implementation 3. The method of implementation 1 or 2, wherein steps (c) and (d) are repeated to yield a thin film coating composed of multiple stacked monolayers deposited on a plurality of the battery material powders within the slurry.

Implementation 4. The method of implementation 3, wherein the thin film coating possesses a thickness of no more than 100 nm.

Implementation 5. The method of any one of implementation 1-3, further comprising mixing or agitating the solvent with the battery material powders to fluidize a plurality of the battery material powders.

Implementation 6. The method of implementation 5, wherein the mixing or agitating is carried out by an overhead stirrer.

Implementation 7. The method of any one of implementations 1-6, further comprising heating the slurry.

Implementation 8. The method of implementation 7, wherein the heating is carried out by a heating jacket.

Implementation 9. The method of any one of implementations 1-8, wherein the battery material powder comprises one or more of the following: graphite, Si, Sn, Ge, Al, P, Zn, Ga, As, Cd, In, Sb, Pb, Bi, SiO, SnO₂, Si, Sn, lithium metal, LiNiₓMn_{y}Co_{z}O₂, LiNiₓCo_{y}Al_{z}O₂, LiMnₓNi_{yOz}, LiMnO₂, LiFePO₄, LiMnPO₄, LiNiPO₄, LiCoPO₄, LiV₂O₅, sulfur or LiCoO₂ where x, y and z are stoichiometric coefficients.

Implementation 10. The method of any one of implementations 1-9, wherein the battery material powder is a solid electrolyte comprising one or more of the following: LiPON, Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Al, Cr, Ga, Fe, Sc, In, Lu, Y or La) or NaₓZr₂Si_{y}PO₁₂, LiₓP_{y}S_{z},, GeS₂, LiₓZn_{y}GeO₄ where in all cases, x, y and z represent stoichiometric coefficients.

Implementation 11. The implementation of any one of implementations 1-10, wherein the solvent includes an organic solvent selected from a group that includes at least one of: isopropyl alcohol, ethanol, 2-methoxyethanol, pyridine tetrahydrofuran (THF), hexane, toluene, dioxane, or diethyl ether .

Implementation 12. The method of any one of implementations 1-11, further comprising adding one or more additional components to the reaction vessel before or after the coating process is performed.

Implementation 13. The method of implementation 12, wherein the one or more additional components comprises conductive and/or adhesive binders.

Implementation 14. The method of implementation 13, wherein the conductive binder is conductive carbon.

Implementation 15. The method of implementation 13, wherein the adhesive binder is poly-vinylidene fluoride (PVDF).

Implementation 16. The method of any one of implementations 1-15, wherein the coated battery material powders are removed from the slurry and dried prior to further processing.

Implementation 17. The method of implementation 16, further comprising exposing the coated battery material powders to a thermal treatment in the presence of an ambient atmosphere comprising a defined composition of gases.

Implementation 18. The method of implementation 17, wherein the gases comprise a mixture of O₂, ozone, N₂, or Ar.

Implementation 19. The method of implementation 18, wherein the coated battery material powders are heated to temperatures up to 1000° C. within the presence of the gases.

Implementation 20. The method of implementation 19, wherein the coated battery material powders are heated while being exposed to a plasma.

Implementation 21. The method of implementation 20, wherein the plasma comprises oxygen, argon, hydrogen, fluorine, or nitrogen.

Implementation 22. The method of any one of implementations 1-21, wherein the thin film monolayer comprises a compound produced by the reaction of the adsorbed first reagent and the second reagent.

Implementation 23. The method of implementation 22, wherein the compound may be selected from the list consisting of: (a) binary oxides of type AₓO_{y}, where A is an alkali metal, alkali-earth metal, transition metal, semimetal, metal or metalloid and x and y are stoichiometric coefficients; (b) ternary oxides of type AₓB_{y}O_{z}, where A and B are any combination of alkali metal, alkali-earth metal, transition metal, semimetal, metal or metalloid and x, y and z are stoichiometric coefficients; (c) quaternary oxides of type A_{w}BₓC_{y}O_{z}, where A, B and C are any combination of alkali metal, alkali-earth metal, transition metal, semimetal, metal or metalloid and w, x, y and z are stoichiometric coefficients; (d) binary halides of type AₓB_{y}, where A is an alkali metal, alkali-earth metal, transition metal, semimetal, metal or metalloid, B is a halogen and x and y are stoichiometric coefficients; (e) ternary halides of type AₓB_{y}C_{z}, where A and B are any combination of alkali metal, alkali-earth metal, transition metal, semimetal, metal or metalloid, C is a halogen and x, y and z are stoichiometric coefficients; (f) quaternary halides of type A_{w}BₓC_{y}D_{z}, where A, B and C are any combination of alkali metal, alkali-earth metal, transition metal, semimetal, metal or metalloid, D is a halogen and w, x, y and z are stoichiometric coefficients; (g) binary nitrides of type AₓN_{y}, where A is an alkali metal, alkali-earth metal, transition metal, semimetal, metal or metalloid and x and y are stoichiometric coefficients; (h) ternary nitrides of type AₓB_{y}N_{z}, where A and B are any combination of alkali metal, alkali-earth metal, transition metal, semimetal, metal or metalloid and x, y and z are stoichiometric coefficients; (i) quaternary nitrides of type A_{w}BₓC_{y}N_{z}, where A, B and C are any combination of alkali metal, alkali-earth metal, transition metal, semimetal, metal or metalloid and w, x, y and z are stoichiometric coefficients; (j) binary chalcogenides of type AₓB_{y}, where A is an alkali metal, alkali-earth metal, transition metal, semimetal, metal or metalloid, B is a chalcogen and x and y are stoichiometric coefficients; (k) ternary chalcogenides of type AₓB_{y}C_{z}, where A and B are any combination of alkali metal, alkali-earth metal, transition metal, semimetal, metal or metalloid, C is a chalcogen and x, y and z are stoichiometric coefficients; (l) quaternary chalcogenides of type A_{w}BₓC_{y}D_{z}, where A, B and C are any combination of alkali metal, alkali-earth metal, transition metal, semimetal, metal or metalloid, D is a chalcogen and w, x, y and z are stoichiometric coefficients; (m) binary carbides of type AₓC_{y}, where A is an alkali metal, alkali-earth metal, transition metal, semimetal, metal or metalloid and x and y are stoichiometric coefficients; (n) binary oxyhalides of type AₓB_{y}O_{z}, where A is an alkali metal, alkali-earth metal, transition metal, semimetal, metal or metalloid, B is a halogen and x, y and z are stoichiometric coefficients; (o) binary arsenides of type AₓAs_{y}, where A is an alkali metal, alkali-earth metal, transition metal, semimetal, metal or metalloid and x and y are stoichiometric coefficients; (p) ternary arsenides of type AₓB_{y}As_{z}, where A and B are any combination of alkali metal, alkali-earth metal, transition metal, semimetal, metal or metalloid and x, y and z are stoichiometric coefficients; (q) quaternary arsenides of type A_{w}BₓC_{y}As_{z}, where A, B and C are any combination of alkali metal, alkali-earth metal, transition metal, semimetal, metal or metalloid and w, x, y and z are stoichiometric coefficients; (r) binary phosphates of type Aₓ(PO₄)_{y}, where A is an alkali metal, alkali-earth metal, transition metal, semimetal, metal or metalloid and x and y are stoichiometric coefficients; (s) ternary phosphates of type AₓB_{y}(PO₄)_{z}, where A and B are any combination of alkali metal, alkali-earth metal, transition metal, semimetal, metal or metalloid and x, y and z are stoichiometric coefficients; and (t) quaternary phosphates of type A_{w}BₓC_{y}(PO₄)_{z}, where A, B and C are any combination of alkali metal, alkali-earth metal, transition metal, semimetal, metal or metalloid and w, x, y and z are stoichiometric coefficients.

Implementation 24. The method of implementation 22, wherein the compound is composed of one or more of the following polymers: polyethylene oxide (PEO), poly vinyl alcohol (PVA), poly methyl methacrylate (PMMA), poly dimethyl siloxane (PDMS), poly vinyl pyrollidone (PVP).

Implementation 25. The method of implementation 24, wherein the one or more polymers also contains a lithium salt comprising LiClO₄, LiPF₆ or LiNO₃.

Implementation 26. The method of implementation 22, wherein the compound is composed of at least one or more metalcone polymers.

Implementation 27. The method of implementation 26, wherein the first reagent can include a metalorganic comprising an organic moiety such as methyl, ethyl, propyl, butyl, methoxy, ethoxy, sec-butoxy, tert-butoxy or similar and a metal comprising Al, Zn, Si, Ti, Zr, Hf, Mn, and/or V, and the second reagent can include an organic molecule comprising ethylene glycol, glycerol, erythritol, xylitol, sorbitol, mannitol, butanediol, pentanediol, penterythritol, hydroquinone, phloroglucinol, hexanediol, lactic acid, triethanolamine, p-phenylenediamine, glycidol, caprolactone, fumaric acid, aminophenol, ethylene diamine, 4,4′-oxydianiline, diethylenetriamine, ethylenediaminetetraacetic acid (EDTA), tris(hydroxymethyl)aminomethane, melamine, and/or diamino diphenyl ether.

Implementation 28. The method of implementation 22, wherein compound comprises at least one or more polymers comprising a polyamide, polyimide, polyurea, polyazomethine, a fluoroelastomer, or any combination of these.

Implementation 29. The method of implementation 3, wherein the coating has a thickness between 0.2 nm and 100 nanometers (nm).

Implementation 30. The method of any one of implementations 1-29, wherein the reaction vessel comprises one or more process monitoring instruments.

Implementation 31. A liquid-phase deposition method for coating thin films onto battery material powders, the method comprising: (a) mixing a solvent with the battery material powders, thereby yielding a slurry composed of the solvent and powders; (b) mixing the first reagent with the slurry, thereby producing battery material powders comprising an adsorbed partial layer of the first reagent; and (c) mixing a second reagent with the battery material powders comprising an adsorbed monolayer of first reagent, thereby yielding coated battery material powders comprising a thin film monolayer.

Implementation 32. A battery comprising an electrode or an electrolyte comprising particles coated with a thin film monolayer generated by a method of any one of claims 1-29.

Implementation 33. The method of any one of implementations 1-30, wherein, the solvent in which the coating is performed is exchanged for a new solvent after the coating process is performed.

Implementation 34. The method of implementation 22, wherein the first or second reagent is chosen from the following list: p-phenylenediamine, ethylene diamine, 2,2′-(ethylenedioxy)bis(ethylamine), 2,2-difluoropropane-1,3-diamine, melamine, benzene-1,3,5-triamine, terephthaloyl dichloride, succinyl chloride, diglycolyl chloride, tetrafluorosuccinyl chloride, hexafluoroglutaryl chloride, benzene-1,3,5-tricarbonyl trichloride, terephthalic acid, succinic acid, hexanedioic acid, diglycolic acid, 2,2,3,3-tetrafluorosuccinic acid, citric acid, propane-1,2,3-tricarboxylic acid, trimesic acid, 1,4 phenylene diisocyanate, hexamethylene diisocyanate, trans-1,4-cyclohexylene diisocyanate, 1,2-bis(2-isocyanatoethoxy)ethane 2,2-difluoro-1,3-diisocyanatopropane, 1,3,5-triisocyanatobenzene, 1,4 phenylene diisothiocyanate, 1,4-butanediisothiocyanate, 1,2-bis(2-isothiocyanatoethoxy)ethane, 2,2-difluoro-1,3-diisothiocyanatopropane, 1,3,5-triisothiocyanatobenzene, 1,4-dibromobenzene, 1,4-diiodobutane, 1,2-bis(2-iodoethoxy)ethane, octafluoro-1,4-diiodobutane, 3,3’,5,5′-tetrabromo-1,1′-biphenyl, 2,2’,7,7′-tetrabromo-9,9′-spirobifluorene, 1,2,5,6-tetrabromohexane, bisphenol A diglycidiyl ether, 4,4′-methylenebis(N,N-diglycidylaniline), butadienediepoxide, 1,4-bis(oxiran-2-ylmethoxy)butane, ethylene glycol diglycidyl ether, triethylene glycol, 2,2,3,3-tetrafluoro-1,4-butanediol diglycidyl ether, trimethylolpropane triglycidyl ether, PSS-octa[(3-glycidyloxypropyl)dimethylsiloxy] substituted, bisphenol A bis(chloroformate), 1,4-phenylene bis(chloroformate), ethylenebis(chloroformate), 1,4-Butanediol bis(chloroformate), tri(ethyleneglycol) bis(chloroformate), 2,2,3,3-tetrafluorobutane-1,4-diyl bis(carbonochloridate), propane-1,2,3-triyl tris(chloroformate), bisphenol A, ethylene glycol, diethylene glycol, 2,2,3,3-tetrafluoro-1,4-butanediol, 2,2,3,3,4,4-hexafluoro-1,5-pentanediol, titanium isopropoxide, glycerol, pentaerythritol, phloroglucinol, glucose, 2-ethyl-2-(hydroxymethyl)propane-1,3-diol, benzene-1,4-dithiol, 1,4-phenylenedimethanethiol, butane-1,4-dithiol, 2,2′-(Ethylenedioxy)diethanethiol, 2,2′-((2,2,3,3-tetrafluorobutane-1,4-diyl)bis(oxy))bis(ethane-1-thiol), trithiocyanuric acid, pentaerythritol tetrakis(3-mercaptopropionate), divinylbenzene, bicycle[2.2.1]hepta-2,5-diene, 1,5-cyclooctadiene, (vinylsulfonyl)ethane, di(ethylene glyocol) divinyl ether, 2,2,3,3,4,4-hexafluoro-1,5-bis(vinyloxy)pentane, trimethylolpropane triacrylate, pentaerythritol tetraacrylate, 1,4-diethynylbenzene, dipropargylamine, 4,7,10,16-pentaoxanonadeca-1,18-diyne, 3,3,4,4-tetrafluorohexa-1,5-diyne, 1,3,5-triethynylbenzene, 2,2′-bifuran, 2,2′-bithiophene, N,N′-bis-furan-2-ylmethyl-malonamide, bis(furan-2-ylmethoxy)dimethylsilane, 1,2-bis(furan-2-ylmethoxy)ethane, 2-(furan-2-ylmethoxymethyl)furan, 2,2′-(((2,2,3,3,4,4-hexafluoropentane-1,5-diyl)bis(oxy))bis(methylene))difuran, 2,2′-(((2-ethyl-2-((furan-2-ylmethoxy)methyl)propane-1,3-diyl)bis(oxy))bis(methylene))difuran, 1,1′-(methylenedi-4,1-phenylene)bismaleimide, N,N′-(1,4-phenylene)dimaleimide, bis-maleimidoethane, dithio-bis-maleimidoethane, 1,8-bismaleimido-diethyleneglycol, 1,1′-(2,2-difluoropropane-1,3-diyl)bis(1H-pyrrole-2,5-dione), 1,1’,1”-(benzene-1,3,5-triyl)tris(1H-pyrrole-2,5-dione), 1,4-diazidobenzene, 1,4-diazidobutane, polyethylene oxide bis(azide), 1,2-bis(2-azidoethoxy)ethane, 1,4-diazido-2,2,3,3-tetrafluorobutane, 1-azido-2,2-bis(azidomethyl)butane, 1,4-phenylenediboronic acid, 1,4-benzenediboronic acid bis(pinacol) ester, (E)-1-heptane-1,2-diboronic acid bis(pinacol) ester, 1,3,5-phenyltriboronic acid, tris(pinacol) ester, 1,4-bis(tributylstannyl)benzene, 2,5-bis(trimethylstannyl)thiophene, trans-1,2-bis(tributylstannyl)ethene, bis(trimethylstannyl)acetylene.

Implementation 35. A method comprising a liquid-phase deposition process for producing a monolayer film on battery material powders, the method comprising: providing a battery material powder to a reaction vessel, the battery material powder comprising a number of battery material particles; providing a solvent to the reaction vessel to produce a first slurry comprised of the solvent and the number of battery material particles; providing a first reagent to the reaction vessel, the first reagent comprising at least a first substance that reacts with the first slurry to produce intermediate battery material particles having an adsorbed partial layer, the adsorbed partial layer comprising the first substance adsorbed to surfaces of the number of battery material particles; providing a second reagent to the reaction vessel, the second reagent comprising at least a second substance that reacts with the adsorbed partial layer to produce a second slurry, the second slurry comprising the number of battery material particles coated with the monolayer film.

Implementation 36. The method of implementation 35, wherein a rotating agitation device is disposed within the reaction vessel, and the method comprises: activating the rotating agitation device to mix the solvent and the battery material powder to produce the first slurry; activating the rotating agitation device to mix the first slurry with the first reagent to produce the intermediate battery material particles; and activating the rotating agitation device to mix the intermediate battery material particles with the second reagent to produce the second slurry

Implementation 37. The method of implementation 35 or 36, wherein the number of battery material particles have a d₅₀ no greater than about 20 micrometers to at least about 0.01 micrometers.

Implementation 38. The method of any one of implementations 35-37, wherein at least one of the first reagent or the second reagent has a vapor pressure at 1 atmosphere and at 25° C. from about 1 Pascal (Pa) to about 3000 Pa.

Implementation 39. The method of any one of implementations 35-38, wherein at least one of the first reagent or the second reagent has a decomposition temperature of at least about 50° C.

Implementation 40. The method of any one of implementations 35-39, wherein the number of battery material particles have an aspherical geometry.

Implementation 41. The method of any one of implementations 35-40, comprising monitoring formation of non-volatile byproducts that are at least partially soluble in the solvent during the liquid phase deposition process with an in-situ reaction probe.

Implementation 42. The method of any one of implementations 35-41, comprising: applying one or more heat treatments to the second slurry to generate an additional powder that comprises the number of battery material particles coated with the monolayer film; forming at least one electrode layer or at least one electrolyte layer of a battery from the additional powder.

Implementation 43. The method of any one of implementations 35-42, wherein a bulk resistivity of the monolayer film is less than a bulk resistivity of the battery material powder.

Implementation 44. The method of any one of implementations 35-43, comprising: recovering a portion of the solvent after the second slurry is formed with an efficiency of at least about 90%.

Implementation 45. The method of any one of implementations 35-44, wherein the battery material powder is a solid electrolyte powder and the monolayer film provides a barrier to prevent water from interacting with the number of battery material particles.

Implementation 46. The method of any one of implementations 35-45, wherein the battery material powder is an electrode active material powder and the monolayer film provides a barrier to prevent water from interacting with the number of battery material particles.

Implementation 47. The method of any one of implementations 35-46, wherein the battery material powder is a cathode active material powder and the monolayer film provides a barrier to prevent oxygen from interacting with the number of battery material particles.

Implementation 48. The method of any one of implementations 35-47, wherein at least one of the first reagent or the second reagent include a solution comprising a material including a metal and an organic moiety, the solution being diluted such that the solution does not ignite when in contact with ambient air and an undiluted form of the solution does ignite when in contact with ambient air.

Implementation 49. The method of any one of implementations 35-48, wherein at least one of the first slurry, the intermediate battery material particles, or the second slurry are heated in the reaction vessel to a temperature from about 30° C. to about 300° C. during the liquid-phase deposition process.

Implementation 50. The method of any one of implementations 35-49, wherein a pressure within the reaction vessel is about 1 atm.

Implementation 51. The method of any one of implementations 35-50, wherein the monolayer film comprises a compound produced by the reaction of the adsorbed partial layer and the second reagent.

Implementation 52. The method of implementation 51, wherein the compound may be selected from the list consisting of: (a) binary oxides of type AₓO_{y}, where A is an alkali metal, alkali-earth metal, transition metal, semimetal, metal or metalloid and x and y are stoichiometric coefficients; (b) ternary oxides of type AₓB_{y}O_{z}, where A and B are any combination of alkali metal, alkali-earth metal, transition metal, semimetal, metal or metalloid and x, y and z are stoichiometric coefficients; (c) quaternary oxides of type A_{w}BₓC_{y}O_{z}, where A, B and C are any combination of alkali metal, alkali-earth metal, transition metal, semimetal, metal or metalloid and w, x, y and z are stoichiometric coefficients; (d) binary halides of type AₓB_{y}, where A is an alkali metal, alkali-earth metal, transition metal, semimetal, metal or metalloid, B is a halogen and x and y are stoichiometric coefficients; (e) ternary halides of type AₓB_{y}C_{z}, where A and B are any combination of alkali metal, alkali-earth metal, transition metal, semimetal, metal or metalloid, C is a halogen and x, y and z are stoichiometric coefficients; (f) quaternary halides of type A_{w}BₓC_{y}D_{z}, where A, B and C are any combination of alkali metal, alkali-earth metal, transition metal, semimetal, metal or metalloid, D is a halogen and w, x, y and z are stoichiometric coefficients; (g) binary nitrides of type AₓN_{y}, where A is an alkali metal, alkali-earth metal, transition metal, semimetal, metal or metalloid and x and y are stoichiometric coefficients; (h) ternary nitrides of type AₓB_{y}N_{z}, where A and B are any combination of alkali metal, alkali-earth metal, transition metal, semimetal, metal or metalloid and x, y and z are stoichiometric coefficients; (i) quaternary nitrides of type A_{w}BₓC_{y}N_{z}, where A, B and C are any combination of alkali metal, alkali-earth metal, transition metal, semimetal, metal or metalloid and w, x, y and z are stoichiometric coefficients; (j) binary chalcogenides of type AₓB_{y}, where A is an alkali metal, alkali-earth metal, transition metal, semimetal, metal or metalloid, B is a chalcogen and x and y are stoichiometric coefficients; (k) ternary chalcogenides of type AₓB_{y}C_{z}, where A and B are any combination of alkali metal, alkali-earth metal, transition metal, semimetal, metal or metalloid, C is a chalcogen and x, y and z are stoichiometric coefficients; (1) quaternary chalcogenides of type A_{w}BₓC_{y}D_{z}, where A, B and C are any combination of alkali metal, alkali-earth metal, transition metal, semimetal, metal or metalloid, D is a chalcogen and w, x, y and z are stoichiometric coefficients; (m) binary carbides of type AₓC_{y}, where A is an alkali metal, alkali-earth metal, transition metal, semimetal, metal or metalloid and x and y are stoichiometric coefficients; (n) binary oxyhalides of type AₓB_{y}O_{z}, where A is an alkali metal, alkali-earth metal, transition metal, semimetal, metal or metalloid, B is a halogen and x, y and z are stoichiometric coefficients; (o) binary arsenides of type AₓAs_{y}, where A is an alkali metal, alkali-earth metal, transition metal, semimetal, metal or metalloid and x and y are stoichiometric coefficients; (p) ternary arsenides of type AₓB_{y}As_{z}, where A and B are any combination of alkali metal, alkali-earth metal, transition metal, semimetal, metal or metalloid and x, y and z are stoichiometric coefficients; (q) quaternary arsenides of type A_{w}BₓC_{y}As_{z}, where A, B and C are any combination of alkali metal, alkali-earth metal, transition metal, semimetal, metal or metalloid and w, x, y and z are stoichiometric coefficients; (r) binary phosphates of type Aₓ(PO₄)_{y}, where A is an alkali metal, alkali-earth metal, transition metal, semimetal, metal or metalloid and x and y are stoichiometric coefficients; (s) ternary phosphates of type AₓB_{y}(PO₄)_{z}, where A and B are any combination of alkali metal, alkali-earth metal, transition metal, semimetal, metal or metalloid and x, y and z are stoichiometric coefficients; and (t) quaternary phosphates of type A_{w}BₓC_{y}(PO₄)_{z}, where A, B and C are any combination of alkali metal, alkali-earth metal, transition metal, semimetal, metal or metalloid and w, x, y and z are stoichiometric coefficients.

Implementation 53. The method of implementation 51, wherein the compound is composed of one or more of the following polymers: polyethylene oxide (PEO), poly vinyl alcohol (PVA), poly methyl methacrylate (PMMA), poly dimethyl siloxane (PDMS), poly vinyl pyrollidone (PVP).

Implementation 54. The method of implementation 53, wherein the one or more polymers also contains a lithium salt comprising LiClO₄, LiPF₆ or LiNO₃.

Implementation 55. The method of implementation 51, wherein the compound is composed of at least one or more metalcone polymers.

Implementation 56. The method of implementation 55, wherein the first reagent includes a metalorganic comprising an organic moiety including at least one of a methyl, ethyl, propyl, butyl, methoxy, ethoxy, sec-butoxy, tert-butoxy group and a metal comprising Al, Zn, Si, Ti, Zr, Hf, Mn, and/or V, and the second reagent includes an organic molecule comprising ethylene glycol, glycerol, erythritol, xylitol, sorbitol, mannitol, butanediol, pentanediol, penterythritol, hydroquinone, phloroglucinol, hexanediol, lactic acid, triethanolamine, p-phenylenediamine, glycidol, caprolactone, fumaric acid, aminophenol, ethylene diamine, 4,4′-oxydianiline, diethylenetriamine, ethylenediaminetetraacetic acid (EDTA), tris(hydroxymethyl)aminomethane, melamine, and/or diamino diphenyl ether.

Implementation 57. The method of implementation 51, wherein the compound comprises at least one or more polymers comprising a polyamide, polyimide, polyurea, polyazomethine, a fluoroelastomer, or any combination of these.

Implementation 58. The method of any one of implementations 35-57, wherein the battery material powder comprises a cathode active material powder.

Implementation 59. The method of any one of implementations 35-58, wherein the battery material powder comprises a solid electrolyte powder.

Implementation 60. A system to perform a liquid-phase deposition process for producing a monolayer film on battery material powders comprising: a reaction vessel; a rotating agitation device disposed within the reaction vessel; a first inlet pipe to provide a battery material powder to the reaction vessel, the battery material powder comprising a number of battery material particles; a second inlet pipe to provide a solvent to the reaction vessel, the solvent combining in the reaction vessel with the battery material powder to produce a first slurry; a third inlet pipe to provide a first reagent to the reaction vessel, the first reagent comprising at least a first substance that reacts with the first slurry to produce intermediate battery material particles having an adsorbed partial layer, the adsorbed partial layer comprising the first substance adsorbed to surfaces of the number of battery material particles; a fourth inlet pipe to provide a second reagent to the reaction vessel, the second reagent comprising at least a second substance that reacts with the adsorbed partial layer to produce a second slurry, the second slurry comprising the number of battery material particles coated with the monolayer film.

Implementation 61. The system of implementation 60, comprising an in-situ reaction probe disposed within the reaction vessel and within liquid disposed in the reaction vessel, the in-situ reaction probe being configured to detect formation of non-volatile byproducts during the liquid phase deposition process.

Implementation 62. The system of implementation 61, wherein the in-situ reaction probe includes an infrared spectroscopy probe.

Implementation 63. The system of implementation 60, comprising a mechanical pump to provide at least one of the first reagent or the second reagent to the reaction vessel.

Implementation 64. The system of implementation 63, wherein the mechanical pump includes a positive-displacement pump, a peristaltic pump, a metering pump, a centrifugal pump, a gear pump, a rotary vane pumps, a diaphragm pump, or a pressure transfer pump.

Implementation 65. The system of implementation 60, comprising a heating jacket to heat contents of the reaction vessel.

Implementation 66. A battery comprising: an anode comprising one or more anode active material layers; a cathode comprising one or more cathode active material layers, individual cathode active material layers of the one or more cathode active material layers comprising a number of cathode active material particles coated with a monolayer film; and one or more solid electrolyte layers disposed between the one or more anode active material layers and the one or more cathode active material layers; wherein the battery is configured to operate at voltages of no greater than about 4 volts.

Implementation 67. The battery of implementation 66, wherein the monolayer film comprises one or more metalcone polymers.

Implementation 68. The battery of implementation 66 or 67, wherein the number of cathode active material particles have a d₅₀ no greater than about 20 micrometers to at least about 0.01 micrometers.

Implementation 69. The battery of any one of implementations 66-68, wherein the number of cathode active material particles have an aspherical geometry.

Implementation 70. The battery of implementation 69, wherein the number of cathode active material particles have an average aspect ratio of at least 1.3:1.

Implementation 71. The battery of any one of implementations 66-70, wherein the number of cathode active material particles are formed by a process comprising: providing a cathode active material powder to a reaction vessel, the cathode active material powder comprising a number of cathode active material particles; providing a solvent to the reaction vessel to produce a first slurry comprised of the solvent and the number of cathode active material particles; providing a first reagent to the reaction vessel, the first reagent comprising a first substance that reacts with the first slurry to produce intermediate cathode active material particles having an adsorbed partial layer, the adsorbed partial layer comprising the first substance adsorbed to surfaces of the number of cathode active material particles; providing a second reagent to the reaction vessel, the second reagent comprising a second substance that reacts with the adsorbed partial layer to produce a second slurry, the second slurry comprising the number of cathode active material particles coated with the monolayer film.

In at least some implementations, the methods and systems of the present disclosure are implemented using, or with the aid of, computer systems. The computer system can be involved in many different aspects of the operation the present methods, including but not limited to, controlling the timing of the opening and closing of valves; detecting the volume of liquid via sensor readings, directing the flow of liquids, such as reagents and buffers, into the reaction chamber; and regulating pumps. In some aspects, the computer system is implemented to automate the methods and systems disclosed herein.

### Examples

100 g of LiNio.₆Mn₀.₂Co₀.₂O₂ cathode active material powder is added to a reaction vessel with 50 mL of THF and stirred to form a slurry. The cathode active material powder possesses a D₅₀ of 10 µm and a specific surface area of 0.5 m²/g. Therefore, total cathode active material surface area in the slurry is ~50 m². Sufficient quantities of first reagent adipic acid in THF and second reagent titanium isopropoxide in THF are added to the slurry sequentially, in a 4:1 molar ratio, to form one monolayer of titanium adipate; the monolayer endpoint being determined when concentration vs time of reaction byproduct isopropanol as measured by in-situ infrared spectrometry approaches asymptote. Monolayer depositions are repeated ten times, to yield LiNio.₆Mn₀.₂Co₀.₂O₂ cathode active material powder uniformly coated with 10 monolayers of titanium adipate.

100 g of Li₇P₃S₁₁ solid electrolyte powder is added to a reaction vessel with 50 mL of dioxane and stirred to form a slurry. The solid electrolyte powder possesses a D₅₀ of 1 µm and specific surface area of 4 m²/g. Therefore total solid electrolyte surface area in the slurry is ~400 m². Sufficient quantities of first reagent terepththaloyl chloride in dioxane and second reagent triethylene glycol in dioxane are added to the slurry sequentially, in a 1:1 molar ratio, to form one monolayer of poly (ethane-1,2-diylbis(oxy))bis(ethane-2,1-diyl) terephthalate; the monolayer endpoint being determined when concentration vs time of reaction byproduct HCl as measured by liquid chromatography with mass spectrometry of extracted reaction solution aliquots approaching asymptote. Monolayer depositions are repeated ten times, to yield Li₇P₃S₁₁ solid electrolyte powder uniformly coated with 10 monolayers of poly (ethane-1,2-diylbis(oxy))bis(ethane-2,1-diyl) terephthalate.

What is claimed is:

1. A method comprising a liquid-phase deposition process for producing a monolayer film on battery material powders, the method comprising:
providing a battery material powder to a reaction vessel, the battery material powder comprising a number of battery material particles;
providing a solvent to the reaction vessel to produce a first slurry comprised of the solvent and the number of battery material particles;
providing a first reagent to the reaction vessel, the first reagent comprising at least a first substance that reacts with the first slurry to produce an intermediate slurry comprising intermediate battery material particles having an adsorbed partial layer, the adsorbed partial layer comprising the first substance adsorbed to surfaces of the number of battery material particles; and
providing a second reagent to the reaction vessel, the second reagent comprising at least a second substance that reacts with the adsorbed partial layer to produce a second slurry, the second slurry comprising the number of battery material particles coated with the monolayer film.

2. The method of claim 1, wherein a rotating agitation device is disposed within the reaction vessel, and the method comprises:
activating the rotating agitation device to mix the solvent and the battery material powder to produce the first slurry;
activating the rotating agitation device to mix the first slurry with the first reagent to produce the intermediate battery material particles; and
activating the rotating agitation device to mix the intermediate battery material particles with the second reagent to produce the second slurry.

3. The method of claim 1, wherein at least one of:
the number of battery material particles have a d₅₀ no greater than about 20 micrometers to at least about 0.01 micrometers; or
the number of battery material particles have an aspherical geometry.

4. The method of claim 1, wherein:
at least one of the first reagent or the second reagent has a vapor pressure at 1 atmosphere and at 25° C. from about 1 Pascal (Pa) to about 3000 Pa; and
at least one of the first reagent or the second reagent has a decomposition temperature of
at least about 50° C.

5. (canceled)

6. (canceled)

7. The method of claim 1, comprising monitoring formation of non-volatile byproducts that are at least partially soluble in the solvent during the liquid phase deposition process with an in-situ reaction probe.

8. The method of claim 1, comprising:
applying one or more heat treatments to the second slurry to generate an additional powder that comprises the number of battery material particles coated with the monolayer film; and
forming at least one electrode layer or at least one electrolyte layer of a battery from the additional powder.

9. The method of claim 1, wherein a bulk resistivity of the monolayer film is less than a bulk resistivity of the battery material powder.

10. The method of claim 1, comprising:
recovering a portion of the solvent after the second slurry is formed with an efficiency of at least about 90%.

11. The method of claim 1, wherein the battery material powder is a solid electrolyte powder and the monolayer film possesses a bulk water diffusivity of <10⁻⁵ cm²/s, thereby providing a barrier to prevent water from interacting with the number of battery material particles.

12. The method of claim 1, wherein the battery material powder is an electrode active material powder and the monolayer film possesses a bulk water diffusivity of <10⁻⁵ cm²/s, thereby providing a barrier to prevent water from interacting with the number of battery material particles.

13. The method of claim 1, wherein the battery material powder is a cathode active material powder and the monolayer film possesses a bulk oxygen diffusivity of <10⁻⁸ cm²/s, thereby providing a barrier to prevent oxygen from interacting with the number of battery material particles.

14. The method of claim 1, wherein at least one of the first reagent or the second reagent include a solution comprising a material including a metal and an organic moiety, the solution being diluted such that the solution does not ignite when in contact with ambient air and an undiluted form of the solution does ignite when in contact with ambient air.

15. The method of claim 1, wherein:
at least one of the first slurry, the intermediate battery material particles, or the second slurry are heated in the reaction vessel to a temperature from about 30° C. to about 300° C. during the liquid-phase deposition process; and
a pressure within the reaction vessel is about 1 atm.

16. (canceled)

17. The method of claim 1, wherein the monolayer film comprises a compound produced by a reaction of the adsorbed partial layer and the second reagent.

18. The method of claim 17, wherein the compound is selected from the list consisting of:
(a) binary oxides of type AₓO_{y}, where A is an alkali metal, alkali-earth metal, transition metal, semimetal, metal or metalloid and x and y are stoichiometric coefficients;
(b) ternary oxides of type AₓB_{y}O_{z}, where A and B are any combination of alkali metal, alkali-earth metal, transition metal, semimetal, metal or metalloid and x, y and z are stoichiometric coefficients;
(c) quaternary oxides of type A_{w}BₓC_{y}O_{z}, where A, B and C are any combination of alkali metal, alkali-earth metal, transition metal, semimetal, metal or metalloid and w, x, y and z are stoichiometric coefficients;
(d) binary halides of type AₓB_{y}, where A is an alkali metal, alkali-earth metal, transition metal, semimetal, metal or metalloid, B is a halogen and x and y are stoichiometric coefficients;
(e) ternary halides of type AₓB_{y}C_{z}, where A and B are any combination of alkali metal, alkali-earth metal, transition metal, semimetal, metal or metalloid, C is a halogen and x, y and z are stoichiometric coefficients;
(f) quaternary halides of type A_{w}BₓC_{y}D_{z}, where A, B and C are any combination of alkali metal, alkali-earth metal, transition metal, semimetal, metal or metalloid, D is a halogen and w, x, y and z are stoichiometric coefficients;
(g) binary nitrides of type AₓN_{y}, where A is an alkali metal, alkali-earth metal, transition metal, semimetal, metal or metalloid and x and y are stoichiometric coefficients;
(h) ternary nitrides of type AₓB_{y}N_{z}, where A and B are any combination of alkali metal, alkali-earth metal, transition metal, semimetal, metal or metalloid and x, y and z are stoichiometric coefficients;
(i) quaternary nitrides of type A_{w}BₓC_{y}N_{z}, where A, B and C are any combination of alkali metal, alkali-earth metal, transition metal, semimetal, metal or metalloid and w, x, y and z are stoichiometric coefficients;
(j) binary chalcogenides of type AₓB_{y}, where A is an alkali metal, alkali-earth metal, transition metal, semimetal, metal or metalloid, B is a chalcogen and x and y are stoichiometric coefficients;
(k) ternary chalcogenides of type AₓB_{y}C_{z}, where A and B are any combination of alkali metal, alkali-earth metal, transition metal, semimetal, metal or metalloid, C is a chalcogen and x, y and z are stoichiometric coefficients;
(l) quaternary chalcogenides of type A_{w}BₓC_{y}D_{z}, where A, B and C are any combination of alkali metal, alkali-earth metal, transition metal, semimetal, metal or metalloid, D is a chalcogen and w, x, y and z are stoichiometric coefficients;
(m)binary carbides of type AₓC_{y}, where A is an alkali metal, alkali-earth metal, transition metal, semimetal, metal or metalloid and x and y are stoichiometric coefficients;
(n) binary oxyhalides of type AₓB_{y}O_{z}, where A is an alkali metal, alkali-earth metal, transition metal, semimetal, metal or metalloid, B is a halogen and x, y and z are stoichiometric coefficients;
(o) binary arsenides of type AₓAs_{y}, where A is an alkali metal, alkali-earth metal, transition metal, semimetal, metal or metalloid and x and y are stoichiometric coefficients;
(p) ternary arsenides of type AₓB_{y}As_{z}, where A and B are any combination of alkali metal, alkali-earth metal, transition metal, semimetal, metal or metalloid and x, y and z are stoichiometric coefficients;
(q) quaternary arsenides of type A_{w}BₓC_{y}As_{z}, where A, B and C are any combination of alkali metal, alkali-earth metal, transition metal, semimetal, metal or metalloid and w, x, y and z are stoichiometric coefficients;
(r) binary phosphates of type Aₓ(PO₄)y, where A is an alkali metal, alkali-earth metal, transition metal, semimetal, metal or metalloid and x and y are stoichiometric coefficients;
(s) ternary phosphates of type AₓB_{y}(PO₄)_{z}, where A and B are any combination of alkali metal, alkali-earth metal, transition metal, semimetal, metal or metalloid and x, y and z are stoichiometric coefficients; and
(t) quaternary phosphates of type A_{w}BₓC_{y}(PO₄)_{z}, where A, B and C are any combination of alkali metal, alkali-earth metal, transition metal, semimetal, metal or metalloid and w, x, y and z are stoichiometric coefficients.

19. The method of claim 17, wherein the compound is composed of one or more of the following polymers: polyethylene oxide (PEO), poly vinyl alcohol (PVA), poly methyl methacrylate (PMMA), poly dimethyl siloxane (PDMS), poly vinyl pyrollidone (PVP).

20. The method of claim 19, wherein the one or more polymers also include a lithium salt comprising LiClO₄, LiPF₆ or LiNO₃.

21. The method of claim 17, wherein:
the compound is composed of at least one or more metalcone polymers;
the first reagent includes a metalorganic comprising an organic moiety and a metal comprising at least one of Al, Zn, Si, Ti, Zr, Hf, Mn, or V; and
the second reagent includes one or more organic molecules comprising at least one of ethylene glycol, glycerol, erythritol, xylitol, sorbitol, mannitol, butanediol, pentanediol, penterythritol, hydroquinone, phloroglucinol, hexanediol, lactic acid, triethanolamine, p-phenylenediamine, glycidol, caprolactone, fumaric acid, aminophenol, ethylene diamine, 4,4′-oxydianiline, diethylenetriamine, ethylenediaminetetraacetic acid (EDTA), tris(hydroxymethyl)aminomethane, melamine, or diamino diphenyl ether.

22. (canceled)

23. The method of claim 21, wherein the compound comprises at least one or more polymers comprising a polyamide, polyimide, polyurea, polyazomethine, a fluoroelastomer, or any combination of these.

24. (canceled)

25. (canceled)

26. A system to perform a liquid-phase deposition process for producing a monolayer film on battery material powders, the system comprising:
a reaction vessel;
a rotating agitation device disposed within the reaction vessel;
a first inlet pipe to provide a battery material powder to the reaction vessel, the battery material powder comprising a number of battery material particles;
a second inlet pipe to provide a solvent to the reaction vessel, the solvent combining in the reaction vessel with the battery material powder to produce a first slurry;
a third inlet pipe to provide a first reagent to the reaction vessel, the first reagent comprising a first substance that reacts with the first slurry to produce an intermediate slurry comprising intermediate battery material particles having an adsorbed partial layer, the adsorbed partial layer comprising the first substance adsorbed to surfaces of the number of battery material particles; and
a fourth inlet pipe to provide a second reagent to the reaction vessel, the second reagent comprising a second substance that reacts with the adsorbed partial layer to produce a second slurry, the second slurry comprising the number of battery material particles coated with the monolayer film.

27. The system of claim 26, comprising an in-situ reaction probe disposed within the reaction vessel and within liquid disposed in the reaction vessel, the in-situ reaction probe being configured to detect formation of non-volatile byproducts during the liquid phase deposition process and the in-situ reaction probe includes an infrared spectroscopy probe or a spectrometry probe operable in at least one of an ultraviolet electromagnetic radiation spectrum or a visible electromagnetic radiation spectrum.

28. (canceled)

29. The system of claim 26, comprising:
a mechanical pump to provide at least one of the first reagent or the second reagent to the reaction vessel, wherein the mechanical pump includes a positive-displacement pump, a peristaltic pump, a metering pump, a centrifugal pump, a gear pump, a rotary vane pumps, a diaphragm pump, or a pressure transfer pump; and
a heating jacket to heat contents of the reaction vessel.

30. (canceled)

31. A battery comprising:
an anode comprising one or more anode active material layers;
a cathode comprising one or more cathode active material layers, individual cathode active material layers of the one or more cathode active material layers comprising a number of cathode active material particles coated with a monolayer film; and
one or more solid electrolyte layers disposed between the one or more anode active material layers and the one or more cathode active material layers;
wherein the battery is configured to operate at voltages of no greater than about 4 volts.

32. The battery of claim 31, wherein:
the monolayer film comprises one or more metalcone polymers;
the number of cathode active material particles have a d₅₀ no greater than about 20 micrometers to at least about 0.01 micrometers; and
the number of cathode active material particles have an average aspect ratio of at least 1.3:1.

33. (canceled)

34. (canceled)
